(19) United States
(12) Patent Application Publication
(10) Pub. No.: US 2012/0314067 A1
(43) Pub. Date: Dec. 13, 2012

(54) INFORMATION PROCESSING DEVICE, TERMINAL DEVICE, INFORMATION PROCESSING SYSTEM, METHOD OF CONTROL OF INFORMATION PROCESSING DEVICE, CONTROL PROGRAM, AND COMPUTER-READABLE RECORDING MEDIUM WHEREUPON THE PROGRAM IS RECORDED

(76) Inventor: Shinichi Kitabayashi, Osaka-shi (JP)

(21) Appl. No.: 13/578,733

(22) PCT Filed: Feb. 10, 2011
(86) PCT No.: PCT/JP2011/052926

§ 371 Date: Aug. 13, 2012

(30) Foreign Application Priority Data
Feb. 15, 2010 (JP) 2010-030572
Feb. 15, 2010 (JP) 2010-030573

(51) Int. Cl. H04N 7/18

(52) U.S. Cl. 348/143; 348/E07.085

(57) ABSTRACT

A server (1) includes: an imaging device control section (12) which causes an imaging device (3) to detect an LED (21) emitting light at a terminal (5) and which determines in which direction the LED (21) is located with respect to the imaging device (3); a memory section (15) in which to store seat position information (18) indicating, for a plurality of candidate seat positions in which a terminal (5) is placed, in which direction each seat position is located with respect to the imaging device (3); and a position determining section (13) which receives login information identifying a user of a terminal (5) and which determines, by using the seat position information (18) and a direction determined by the imaging device control section (12), in which of the plurality of seat positions the terminal (5) of the user identified by the login information has been placed.

### TECHNICAL FIELD

The present invention relates to information processing devices, etc. for use in electronic conferencing systems and, more specifically, to an information processing device, etc. that shows the positions of seats in which each participant in an electronic conferencing system is seated.

### BACKGROUND ART

In recent years, teleconference systems have been more and more in widespread use. A teleconference system enables a face-to-face conference between physically-remote bases by connecting a plurality of bases via a network, sending and receiving pictures and sounds to and from each base via the network, causing a display device installed at each base to display pictures, and causing a loudspeaker installed at each base to output sounds.

Such a teleconference system is described with reference to FIG. 27. FIG. 27 is a diagram showing an overview of a conventional teleconference system. As shown in FIG. 27, it is assumed here that three participants at a base A and two participants at a base B have a teleconference with each other.

Installed at each of the bases A and B is a display device mounted with a camera. A picture of the participants at the base A is taken by the camera, sent to the base B, and displayed by the display device at the base B. Similarly, a picture of the participants at the base B is taken by the camera, sent to the base A, and displayed by the display device at the base A.

This allows the participants at the base A to see the participants at the base B through the display device at the base A, and allows the participants at the base B to see the participants at the base A through the display device at the base B, thus enabling a face-to-face conference between physically-remote bases.

An example of a prior art document that relates to a teleconference system is Patent Literature 1, which is listed below. Patent Literature 1 describes having each participant in an electronic conferencing system wear a small-sized electronic device that emits infrared rays, using a camera to detect infrared rays that are emitted by pressing a button provided on the electronic device, and determining the position of that participant in a picture taken by the camera.

Further, in recent years, an electronic conferencing system has just been in widespread use which realizes a paperless conference by allocating terminal devices to each separate participant in a conference and causing the terminal devices to display materials, etc. for the conference.

Such an electronic conferencing system is described with reference to FIG. 28. FIG. 28 is a diagram showing an overview of a paperless electronic conferencing system. As shown in FIG. 28, six participants allocated terminals, respectively. Further, a large-sized display device is provided for all of the participants to look at.

In this electronic conferencing system, the materials for the conference, which would have been distributed in the form of paper medium to participants in a conventional conference, are displayed at each participant's terminal and on the display device, so that the conference is made paperless. Further, in such an electronic conferencing system, too, as in a teleconference system, a face-to-face conference between physically-remote bases is enabled by connecting one base to another via a network.

### CITATION LIST

### Patent Literature 1

Japanese Patent Application Publication, Tokukaihei, 6-105307 A (Publication Date: Apr. 15, 1994)

### SUMMARY OF INVENTION

### Technical Problem

However, the conventional electronic conferencing system is unable to automatically determine who is sitting in which seat, albeit highly computerized with the terminals allocated to each separate participant. This undesirably makes it difficult to for each participant to recognize who is in the conference and who is seated where.

Therefore, as with a non-computerized conventional conference, the conventional electronic conferencing system also requires a cumbersome and complicated job of placing a name plate at each seat, etc. so that each participant can recognize who is seated where in the conference room. Moreover, since each participant needs to be seated in the seat at which his/her name plate has been placed, he/she cannot freely choose his/her seat.

The present invention has been made in view of the foregoing problems, and it is an object of the present invention to provide an information processing device, etc. that automatically determines the seat position of each terminal's user (i.e., each conference participant).

### Solution to Problem

In order to solve the foregoing problems, an information processing device according to the present invention is an information processing device that is in communications connection with a terminal device including a light-emitting section, including: direction determining means which uses a detection device to detect the light-emitting section emitting light at the terminal device and which determines in which direction the light-emitting section is located with respect to the detection device; identifying information receiving means which receives via the communications connection from the terminal device user identifying information identifying a user who uses the terminal device; and position determining means which determines, by using the direction determined by the direction determining means and information for determining the position of the terminal device in the direction, the position of the terminal device of the user identified by the user identifying information received by the identifying information receiving means.

Further, a method for controlling an information processing device according to the present invention is a method for controlling an information processing device that is in communications connection with a terminal device including a light-emitting section, including the steps of: (a) using a detection device to detect the light-emitting section emitting light at the terminal device and determining in which direction the light-emitting section is located with respect to the detection device; (b) receiving via the communications connection from the terminal device user identifying information identifying a user who uses the terminal device; and (c) determining, by using the direction determined in step (a) and information for determining the position of the terminal device in the direction, the position of the terminal device of the user identified by the user identifying information received in step (b).

According to the foregoing configuration, a light-emitting section emitting light is detected by the detecting device, and in which direction the light-emitting section is located with respect to the detection device is determined. It should be noted that in a case where a light-emitting section is detected by a detection device having a defined detection range, the direction in which a light-emitting section is located can be determined by an angle of rotation at which the light-emitting section has been brought into the detection region by rotating the detection range on a predetermined axis of rotation.

Moreover, according to the foregoing configuration, user identifying information identifying a user who uses a terminal device is received from the terminal device, and the position of the terminal device of the user identified by the user identifying information is determined by using the direction thus determined and information for determining the position of the terminal device in the direction.

Therefore, the seat position of each user who uses a terminal device can be automatically determined. It should be noted that the information for determining the position of a terminal device may be information for determining, from the direction thus determined, that one of a plurality of seats on which the terminal device on the user has been placed, or may be information for determining how far in the direction thus determined the terminal device is located.

### Advantageous Effects of Invention

As described above, an information processing device is configured to include: direction determining means which uses a detection device to detect a light-emitting section emitting light at a terminal device and which determines in which direction the light-emitting section is located with respect to the detection device; identifying information receiving means which receives via the communications connection from the terminal device user identifying information identifying a user who uses the terminal device; and position determining means which determines, by using a direction determined by the direction determining means and information for determining the position of a terminal device in the direction, the position of a terminal device of a user identified by user identifying information received by the identifying information receiving means.

Further, a method for controlling an information processing device according to the present invention is configured to include the steps of: (a) using a detection device to detect a light-emitting section emitting light at a terminal device and determining in which direction the light-emitting section is located with respect to the detection device; (b) receiving via the communications connection from the terminal device user identifying information identifying a user who uses the terminal device; and (c) determining, by using a direction determined in step (a) and information for determining the position of a terminal device in the direction, the position of a terminal device of a user identified by user identifying information received in step (b).

This brings about an effect of making it possible to automatically determine the seat position of the user of each terminal device.

Additional objects, features, and strengths of the present invention will be made clear by the description below. Further, the advantages of the present invention will be evident from the following explanation in reference to the accompanying drawings.

### BRIEF DESCRIPTION OF DRAWINGS

FIG. 1 is a block diagram showing configurations of main parts of a server and each terminal that constitute an electronic conferencing system of the present invention.

FIG. 2 is a block diagram showing an example configuration of the electronic conferencing system.

FIG. 3 is a block diagram showing a configuration of the electronic conferencing system in more detail.

FIG. 4 is a diagram showing an example of a screen image that is displayed on a display device in the electronic conferencing system.

FIG. 5 is a timing chart showing an example of the flow of a process in the electronic conferencing system.

FIG. 6 is a timing chart showing an example of the flow of a process in the electronic conferencing system, the process including a process that is carried out in a case where after sending an instruction to turn on an LED, the server cannot detect the LED thus turned on.

FIG. 7 is a diagram showing an example of a table of terminal information that is used by the server and the terminal.

FIG. 8 is a diagram showing an example of a table of positions that is used by the server and the terminal.

FIG. 9 is a set of diagrams (a) to (c) showing example arrangements of seats, (a) of FIG. 9 showing an example of a dual-row arrangement where two rows of seats are arranged in a direction perpendicular to the display surface of the display device, (b) of FIG. 9 showing an example of a U-shaped arrangement where a row parallel to the display surface is provided in addition to the two rows of seats, (c) of FIG. 9 showing an example of a circular arrangement where seats are arranged in a circle.

FIG. 10 is a diagram showing an example of seat position information that is used by the server and the terminal.

FIG. 11 is a set of diagrams (a) and (b) each explaining a method for measuring an angle at which a lighted LED has been detected, (a) of FIG. 9 showing a measuring method that is employed in a case where the seats are not arranged in a circle, (b) of FIG. 9 showing a measuring method that is employed in a case where the seats are arranged in a circle.

FIG. 12 is a flow chart showing an example of a process that is executed by the server.

FIG. 13 is a flow chart showing an example of a process for creating a table of positions that is executed by the server.

FIG. 14 is a flow chart showing an example of a position display process that is executed by the server.

FIG. 15 is a set of diagrams (a) and (b) each showing an example of a seating chart that is displayed by the position display process, (a) of FIG. 15 showing an example of a seating chart displayed so that the display device is on the right side of the seats, (b) of FIG. 15 showing an example of a seating chart displayed so that the display device is on the upper side of the seats.

FIG. 16 is a flow chart showing an example of a position display process (terminal) that is executed by the terminal.

FIG. 17 is a diagram that classifies a U-shaped arrangement of seats into three rows a to c according to the direction in which the participant sitting in each seat faces.

FIG. 18 is a set of diagrams (a) to (c) each showing an example of a seating chart that is displayed by the position display process (terminal), (a) showing an example of a seating chart displayed in a display pattern A, (b) showing an example of a seating chart displayed in a display pattern B, (c) showing an example of a seating chart displayed in a display pattern C.

FIG. 19 is a flow chart showing an example of a position display process (terminal) that is executed by the terminal in a case where the seats are arranged in a circle.

FIG. 20 is a diagram showing an example of a seating chart that is displayed by a position display process (terminal) in a case where the seats are arranged in a circle.

FIG. 21 is a block diagram showing configurations of main parts of a server and each terminal that are included in an electronic conferencing system according to another embodiment of the present invention.

FIG. 22 is a diagram showing an example of a table of terminal information that is used by the server and the terminal.

FIG. 23 is a flow chart showing an example of a process that is executed by the server.

FIG. 24 is a flow chart showing an example of a position display process that is executed by the server.

FIG. 25 is a flow chart showing an example of a position display process (terminal) that is executed by the terminal.

FIG. 26 is a flow chart showing an example of a position display process (terminal) that is executed by the terminal in a case where the seats are arranged in a circle.

FIG. 27 is a diagram showing an overview of a conventional teleconference system.

FIG. 28 is a diagram showing an overview of a paperless electronic conferencing system.

### DESCRIPTION OF EMBODIMENTS

### Embodiment 1

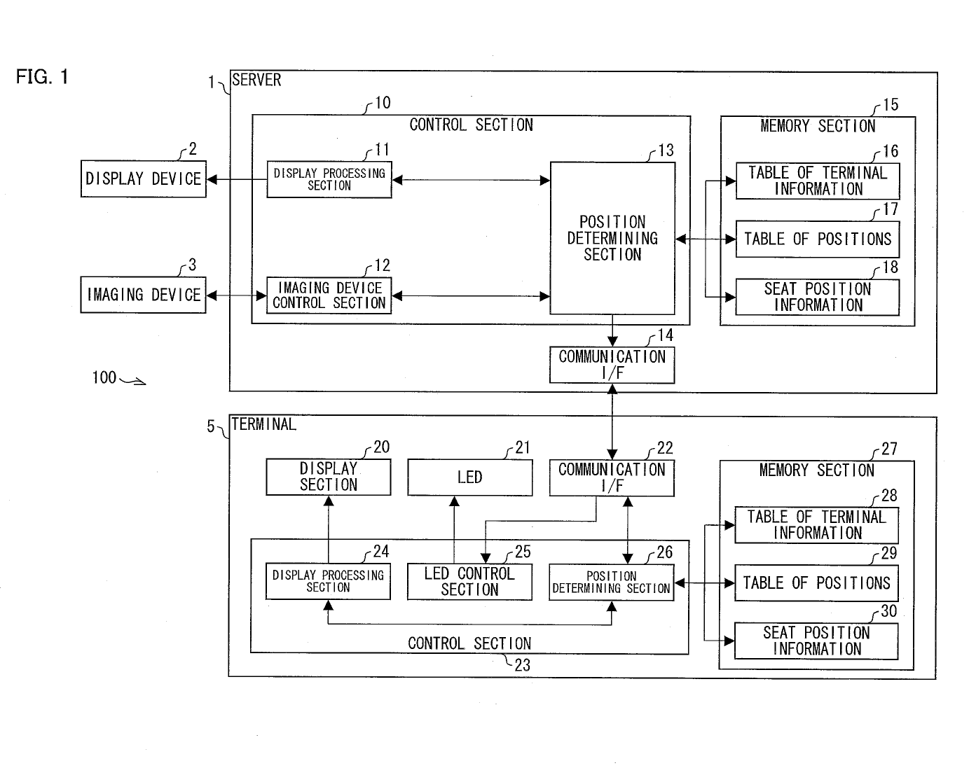

A first embodiment of the present invention is described in detail below with reference to FIGS. 1 through 20.

[Overview of an Electronic Conferencing System]

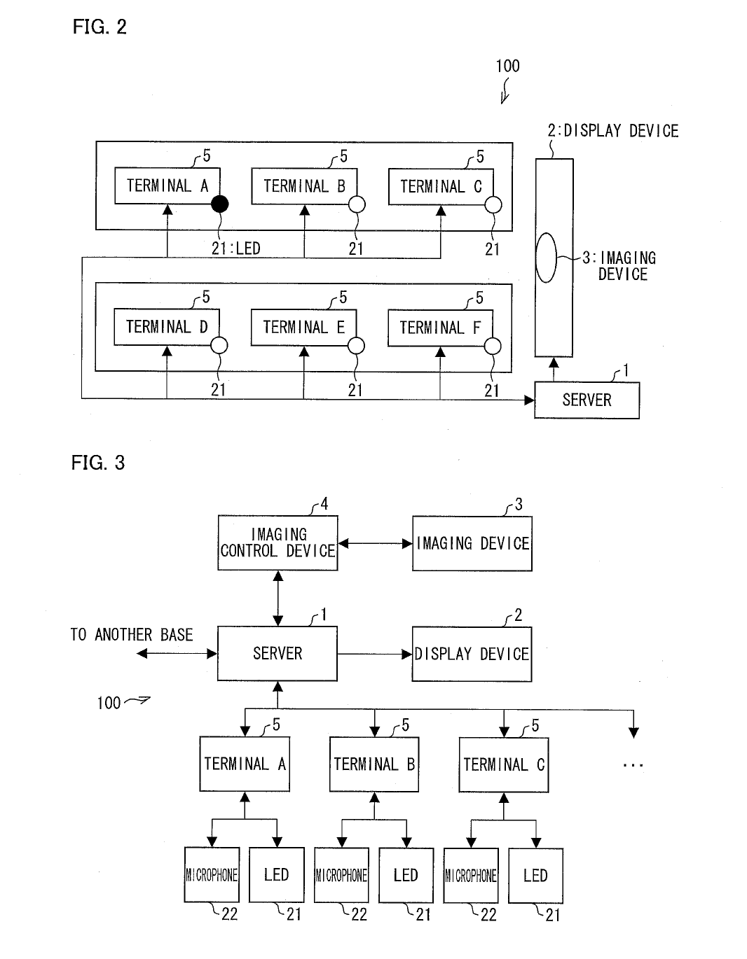

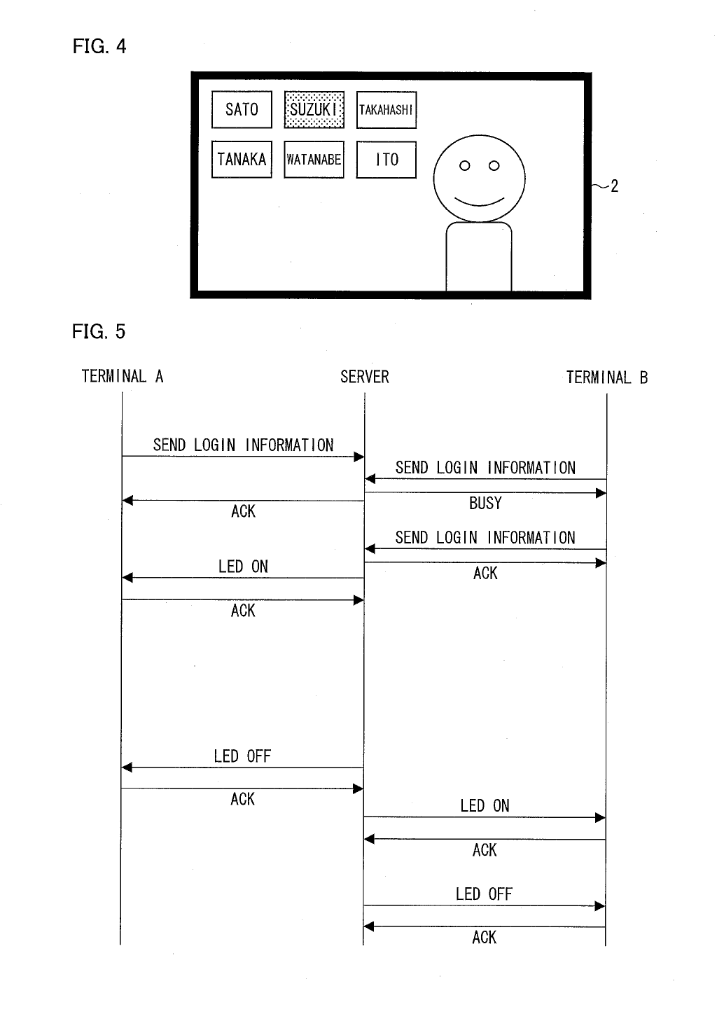

First, an overview of an electronic conferencing system of the present embodiment is described below with reference to FIGS. 2 through 4. FIG. 2 is a block diagram showing an example configuration of an electronic conferencing system (information processing system) 100. FIG. 3 is a block diagram showing a configuration of the electronic conferencing system in more detail. FIG. 4 is a diagram showing an example of a screen image that is displayed on the display device in the electronic conferencing system.

As shown in FIG. 2, the electronic conferencing system 100 is configured to include a server (information processing device) 1, a display device 2, an imaging device (detection device) 3, and terminals (terminal devices) 5. Each of the terminals 5 is provided with an LED (light-emitting diode, light-emitting section) 21.

It should be noted that FIG. 2 shows six terminals 5 discriminated from each other by being identified as terminals A to F, respectively. Further, FIG. 2 shows a state in which the terminal A has its LED 21 turned on and the terminals B to F have their LEDs 21 turned off.

The server 1 is a device that has overall control of the electronic conferencing system 100. Specifically, the server 1 is communicably connected to the display device 2, the imaging device 3, and the terminals 5. By using the communications connection, the server 1 causes the display device 2 to display an image, causes the imaging device 3 to take an image, and controls the operation of the terminals 5. It should be noted that communication between the server 1 and the other devices may be performed by cable or wireless.

The display device 2 is a device that displays an image under the control of the server 1. In the electronic conferencing system 100, the display device 2 is used for displaying an image (picture) that participants in a conference view together. For example, the display device 2 displays an image for the proceedings of the conference, materials for the conference, pictures of the participants as taken by the imaging device 3, etc. Further, the display device 2 displays a seating chart for the participants in the conference. The seating chart thus displayed is one generated by the server 1 determining the position of each participant in a conference room. The details will be described later.

The imaging device 3 is a device that takes moving images of the participants in the conference, and operates under the control of the server 1. Although not shown in FIG. 2, the imaging device 3 is fixed on the top edge of the display device 2 via a supporting member so that an image can be taken of any participant by causing the imaging device 3 horizontally rotate on the supporting member as an axis of rotation and shift its imaging region. Moreover, a moving image taken by the imaging device 3 is outputted to the server 1, and is displayed on the display device 2 via the server 1. Further, the imaging device 3 is also used to determine the positions of the terminals 5, which are used by the participants in the conference, in the conference room.

Although an example is explained here where the imaging device 3, which is used to take images of the participants, is also used to determine the positions of the terminals 5, an imaging device for determining the positions of the terminals 5 may be provided separately from an imaging device that is used to take images of the participants. However, the diversion of an imaging device that is used to take images of the participants brings about such a merit that the cost of building the electronic conferencing system 100 can be reduced.

Each of the terminals 5 is a device that is used by each separate conference participant, and carries out a display, etc. of the materials for use in the conference. Further, each of the terminals 5 includes an LED 21. The LED 21 is used for showing the operating state (ON/OFF of power, etc) of the terminal 5, and is also used in determining the position of the terminal 5. That is, the terminal 5 turns on the LED 21 in accordance with an instruction from the server 1. Then, server 1 determines the position of the terminal 5 in the conference room by using the imaging device 3 to detect the LED 21 thus turned on.

Although not illustrated in FIG. 2, each of the terminals 5 includes a touch-panel display section, thereby allowing its user to write with a pen, a finger, or the like on a document displayed on the display section. Moreover, the terminal 5 can also sends an image being displayed on the display section to the server 1 so that the display device 2 can display the image.

That is, in the electronic conferencing system 100, the conference is conducted by using the display device 2. Moreover, each participant participates in the conference while looking at the conference materials with his/her terminal 5, writes as needed on a document displayed on his/her terminal 5, and causes the display device 2 to display the document via the server 1. This allows him/her to present the document to the other participants.

Further, the display device 2 displays a seating chart generated by the server 1 determining the position of each participant in the conference room. This allows each participant to easily recognize who is sitting in which seat in the conference room. A main feature of the electronic conferencing system 100 lies in a process for generating and displaying such a seating chart.

Next, a configuration of the electronic conferencing system 100 is described in more detail with reference to FIG. 3. As shown in FIG. 3, the electronic conferencing system 100 has an imaging control device 4 connected between the server 1 and the imaging device 3. That is, the server 1 controls the operation of the imaging device 3 via the imaging device control device 4. It should be noted that the imaging control device 4 may be configured separately from the server 1 as in the illustrated example, or may be built in the server 1.

Further, as shown in FIG. 3, each of the terminals 5 includes an LED 21 and a microphone 22. The terminal 5 converts a voice inputted to the microphone 22 into voice data and sends the voice data to the server 1 so that the server 1 output the sound through its loudspeaker (not illustrated). This allows each participant to clearly communicate his/her ideas or opinions to the other participants. It should be noted that either the terminal 5 may output the sound, or the sound may be outputted from a loudspeaker connected to the terminal 5.

Moreover, in the illustrated example, it is assumed that the server 1 is in communications connection with another base. Thus, in the electronic conferencing system 100, it is also possible to hold a remote conference by connecting the server 1 to a network (e.g., a LAN, the Internet, or the like). In this case, an image taken of each participant by the imaging device 3 is send to the other base, and an image of participants at the other base as received from the other base is displayed on the display device 2.

A seating chart is displayed in such an aspect as that shown in FIG. 4. As shown in FIG. 4, an image taken of a participant by the imaging device 3 is displayed on the right side of the screen of the display device 2, with the seating chart being displayed on the left side of the screen. It should be noted that this seating chart is not a predetermined seating chart but one generated by detecting the terminal 5 at each seat.

By thus displaying the seating chart generated by detecting the terminal 5 at each seat, the need for a cumbersome and complicated job of creating a seating chart in advance, placing a name plate at each seat, etc. is eliminated. This brings about such a merit that each participant can freely choose his/her seat.

Further, on the seating chart, the name “SUZUKI” is highlighted, which indicates that Mr. Suzuki is speaking by using the microphone 22 of the terminal 5. Moreover, the participant being displayed on the same screen is also Mr. Suzuki, who is currently speaking. That is, upon receiving voice data from a terminal 5, the server 1 causes the terminal 5 from which the voice data has been sent to be highlight-displayed on the seating chart, and causes the imaging device 3 to take an image of a participant using the terminal 5 from which the voice data has been sent.

[Flow of a Process in the Electronic Conferencing System 100]

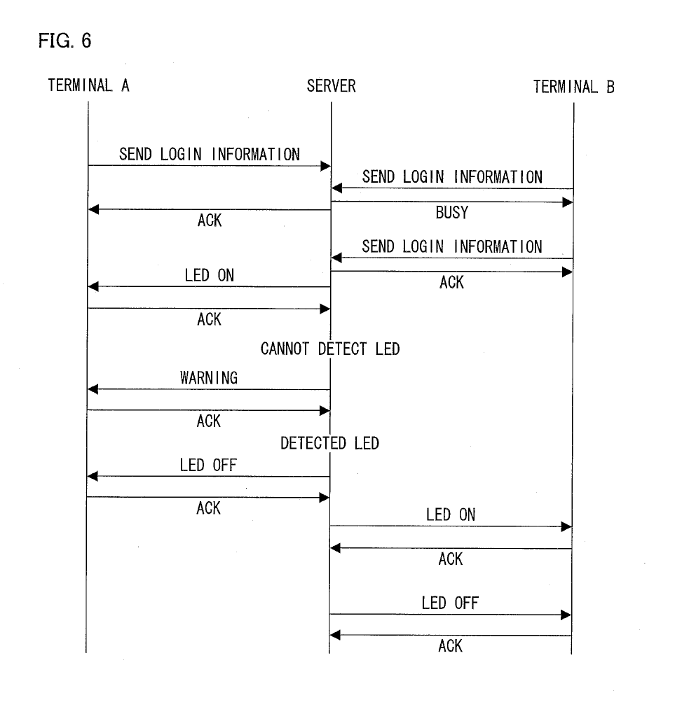

Next, the flow of a process in the electronic conferencing system 100 is described with reference to FIGS. 5 and 6. FIGS. 5 and 6 are each a timing chart showing an example of the flow of a process in the electronic conferencing system 100. For simplicity of explanation, an example is given here where two terminals, namely a terminal A and a terminal B, log in. However, the same applies to a process that is carried out in a case where the number of terminals that log in is three or more.

First, when a conference participant logs in by inputting login information (user identifying information) to the terminal A, the terminal A sends the login information to the server 1. Similarly, when another conference participant logs in by inputting login information to the terminal B, the terminal B sends the login information to the server 1.

Since it is assumed here that the server 1 processes the login information on a first-come-first-served basis, the server sends the terminal B a message “BUSY” indicating that the server 1 is busy and therefore unable to execute the process requested. On the other hand, the server 1 sends the terminal A a message “ACK” indicating that the information sent has been accepted.

The terminal B, which has received BUSY, resends the login information after a particular period of time has elapsed. In the illustrated example, by the time the server 1 receives the login information thus resent, the server 1 has finished sending ACK to the terminal A and therefore is no longer busy, sends ACK in response to the login information resent from the terminal B. It should be noted that the server 1 may keep sending back BUSY to the terminal B until the seat position of the terminal A is determined.

Next, the server 1 sends the terminal A a command to turn on its LED 21. Upon receiving this command, the terminal A sends ACK to the server 1. After this, the server 1 detects a terminal 5 in the conference room whose LED 21 has been turned on, and determines that the terminal 5 thus detected is the terminal A. Further, the server 1 determines that the seat in the position where the terminal 5 has been detected is a seat occupied by the participant who has logged into the terminal A, creates a seating chart on the basis of this determination, and causes the display device 2 to display the seating chart thus created. Then, the server 1 sends the terminal A an instruction to turn off its LED 21. Upon receiving this instruction, the terminal A sends ACK to the server 1.

The subsequent process is finished in the same manner by sending the terminal B an instruction to turn on its LED 21 and receiving ACK from the terminal B, determining the seat position of the participant who has logged into the terminal B, and then sending the terminal B an instruction to turn off its LED 21 and receiving ACK. It should be noted that the LED 21 may be automatically turned off after a particular period of time has elapsed since the sending of an instruction to turn on the LED 21. In this case, it is not necessary to send an instruction to turn off the LED 21. Further, the terminals A and B may automatically turn on their LEDs 21 after sending the login information to the server 1 and receiving ACK. In this case, it is not necessary for the server 1 to send the terminal A or B an instruction to turn on its LED 21.

This is how the server 1 determines the seat position of each participant using a terminal 5 and causes the display device 2 to display a seating chart showing the seat position. This allows the conference participants to easily recognize who is sitting in which seat in the conference room.

The timing chart of FIG. 6 is substantially identical to that of FIG. 5, but differs in that the timing chart of FIG. 6 includes a process that is carried out in a case where after sending an instruction to turn on an LED 21, the server 1 cannot detect the LED 21 thus turned on. An explanation is given here with a focus on this point of difference.

In a case where the server 1 has sent a terminal 5 (the terminal A, here) an instruction to turn on its LED 21 and received ACK from the terminal A but cannot detect the LED 21, the server 1 sends WARNING (warning) to the terminal A. Upon receiving WARNING, the terminal A sends ACK to the server 1.

Possible causes of the inability to detect the LED 21 thus turned on are mostly an obstacle between the LED 21 and the imaging device 3. Therefore, the terminal A, which has received WARNING, carries out a display, a voice output, or the like, for example, to prompt the participant to move the obstacle so that the LED 21 can be seen from the imaging device 3.

In a case where the LED 21 has been detected after the sending of the warning, the server 1 determines the seat position of the participant using the terminal A in accordance with a result of the detection of the LED 21. After that, the server 1 sends the terminal A an instruction to turn off the LED 21 and receives ACK from the terminal A. The seat position of the participant using the terminal B is also determined in the same manner as above. It should be noted that in a case where the LED 21 thus tuned on is not detected even after a warning has been sent, the server 1 may send another warning to the terminal A, or may make a shift to instructing the terminal B to turn on its LED 21 with confirmation of the position of the terminal A being suspended or canceled.

[Configurations of Main Parts of the Server 1 and Each Terminal 5]

Next, configurations of main parts of the server 1 and each terminal 5 are described with reference to FIG. 1. FIG. 1 is a block diagram showing configurations of main parts of the server 1 and each terminal 5. It should be noted that FIG. 1 omits to illustrate the imaging control device 4.

First, a configuration of a main part of the server 1 is described. As shown in FIG. 1, the server 1 includes a control section 10, a communication I/F 14, and a memory section 15.

The control section 10 has overall control of the operation of the server 1, and includes a display processing section (display processing means) 11, an imaging device control section (direction determining means) 12, and a position determining section (identifying information receiving means, terminal control means, position determining means, image sending means, candidate position sending means) 13.

The display processing section 11 carries out a process for causing the display device 2 to display an image. Specifically, the display processing section 11 causes the display device 2 to display images taken by the imaging device 3, materials for a conference as stored in the memory section 15, and the like. Further, the display processing section 11 causes the display device 2 to display an image of a seating chart having the full name of each participant listed thereon. The details will be described later.

The imaging device control section 12 controls the operation of the imaging device 3 via the imaging control device 4 shown in FIG. 3. Specifically, the imaging device control section 12 controls the imaging device 3 so that the imaging device 3 starts or stops shooting, so that the imaging device 3 shifts its imaging region by rotating on a predetermined axis of rotation, so that the imaging device 3 focuses on an imaging target, such as a participant or an LED 21, in the imaging region, so that the imaging device 3 zooms in such an imaging target, and the like. It should be noted that these controls may be carried out by a participant's operating the imaging device 3 or the imaging control device 4.

Further, in accordance with an instruction from the position determining section 13, the imaging device control section 12 detect a lighted LED 21 via the imaging device 3 and determines in which direction the LED 21 is located with respect to the imaging device 3. Specifically, the imaging device control section 12 causes the imaging device 3 to rotate on the aforementioned axis of rotation and shift its imaging region, thereby searching for and detecting a lighted LED 21 at a terminal 5 placed at any one of the seats in the conference room. Then, the imaging device control section 12 determines an angle of rotation at which the lighted LED 21 comes into the center of the imaging region of the imaging device 3. This angle of rotation indicates in which direction the LED 21 is located with respect to the imaging device 3.

It should be noted that the imaging device control section 12 needs only detect a lighted LED 21 and determine in which direction the LED 21 thus detected is located with respect to a predetermined reference position. For example, the imaging device control section 12 may detect a lighted LED 21 and determine the direction by causing the imaging device 3 to rotate itself on a predetermined axis of rotation, or may detect a lighted LED 21 and determine the direction by causing the imaging device 3 to shift its imaging region without moving itself. Further, the direction of an LED 21 detected may be determined from the angle of rotation of the imaging device 3 or the angle of rotation of the imaging region, or may be determined from azimuth or the like.

The position determining section 13 carries out a process for determining who is using which of the plurality of seats set out in the conference room. Specifically, upon receiving login information via the communication I/F 14, the position determining section 13 commands the terminal 5 from which the login information was sent to turn on its LED 21, and causes the imaging device control section 12 to detect the LED 21 thus turned on. Then, the position determining section 13 determines, from the angle of rotation of the imaging device 3 at which the LED 21 thus turned on has been detected, the seat position in which the terminal 5 has been placed, i.e., the seat position of the user who uses the terminal 5. The position determining section 13 determines the seat position of each participant by carrying out such a process for each terminal 5.

The communication I/F 14 is an interface via which the server 1 communicates with another device. The server 1 communicates with each terminal 5 via the communication I/F 14.

The memory section 15 is a memory device in which to store data necessary for the server 1 to operate. The memory section 15 has a table of terminal information 16, a table of positions 17, and seat position information (position-to-direction correspondence information) 18 stored therein. These tables and the information will be described later.

Next, a configuration of a main part of each terminal 5 is described. As shown in FIG. 1, each terminal 5 includes a display section 20, an LED 21, a communication I/F 22, a control section 23, and a memory section 27. It should be noted each terminal 5 may include a microphone 22 as shown in FIG. 2.

The display section 20 is a device that displays an image. Further, it is assumed here that the display section 20 is constituted by a touch panel. That is, the display section 20 functions both as a display device and an input device that accepts an input operation performed on the terminal 5. It should be noted that an input operation on the terminal 5 is not limited to that which performed by the touch panel, but may be performed by using a pointing device such as a mouse or a key input device such as a keyboard.

The display section 20 displays materials for a conference and the like, and also displays a seating chart. A seating chart that is displayed on the display section 20 of each terminal 5 in such an orientation that each participant can easily grasp his/her positional relationship with the other participants according to the position of his/her seat. The details will be described later.

The LED 21 is a light-emitting member that is turned on and off under the control of the control section 23. The LED 21 is used for indicating the operating state of the terminal 5, and is also used in determining the position of the terminal 5. As such, the LED 21 is provided in a position that can be seen from the imaging device 3. An example is given here where the LED 21 is used as a light-emitting member. However, the light-emitting member needs only be turned on and off under the control of the control section 23 and emit light that can be detected by the imaging device 3, and as such, is not limited to an LED. Further, although, in this example, the LED 21, which shows the operating state of the terminal 5, is also used to determine the position of the terminal 5, a light-emitting member for determining the position of the terminal 5 may be provided separately from the LED 21.

The communication I/F 22 is an interface via which the terminal 5 communicates with another device. The terminal 5 communicates with the server 1 via the communication I/F 22.

The control section 23 has overall control of the operation of the terminal 5, and includes a display processing section (terminal-side display processing means) 24, an LED control section (light emission control means) 25, and a position determining section (identifying information sending means) 26.

The display processing section 24 carries out a process for causing the display section 20 to display an image. Specifically, the display processing section 24 causes the display section 20 to display images taken by the imaging device 3, materials for a conference as stored in the memory section 27, and the like. Further, the display processing section 24 causes the display section 20 to display an image of a seating chart having the full name of each participant listed thereon, in such an orientation that the seat at which the terminal has been placed faces upward in the image. The details will be described later.

When login information has been inputted to the terminal 5, the position determining section 26 sends the login information thus inputted to the server 1 via the communication I/F 22. Further, the position determining section 26 receives, from the server 1 via the communication I/F 22, information such as the angle of rotation of the imaging device 3 at which a lighted LED 21 at each terminal 5 has been detected, and determines the seat position of each participant by using the information.

The LED control section 25 turns on or off the LED 21 in accordance with a command sent from the server 1 via the communication I/F 22.

The memory section 27 is a memory device in which to store data necessary for the terminal 5 to operate. The memory section 27 has a table of terminal information 28, a table of positions 29, and seat position information 30 stored therein. These tables and the information are identical to the table of terminal information 16, the table of positions 17, and the seat position information 18, which are stored in the memory section 15 of the server 1.

[Details of the Table of Terminal Information 16]

Next, the table of terminal information 16 is described in detail. The table of terminal information 16 is a table for managing a terminal 5 having logged into the electronic conferencing system 100. When a terminal 5 has logged in, information on that terminal 5 is stored in the table.

Specifically, the table of terminal information 16 contains identification information for identifying a terminal 5 having logged in, the full name of a participant in the conference who uses the terminal 5, and the like. This makes it possible to determine which terminal 5 is being used and who is using that terminal 5. Further, the table of terminal information 16 also contains information indicating the seat position of each terminal 5 as determined by the position determining section 13.

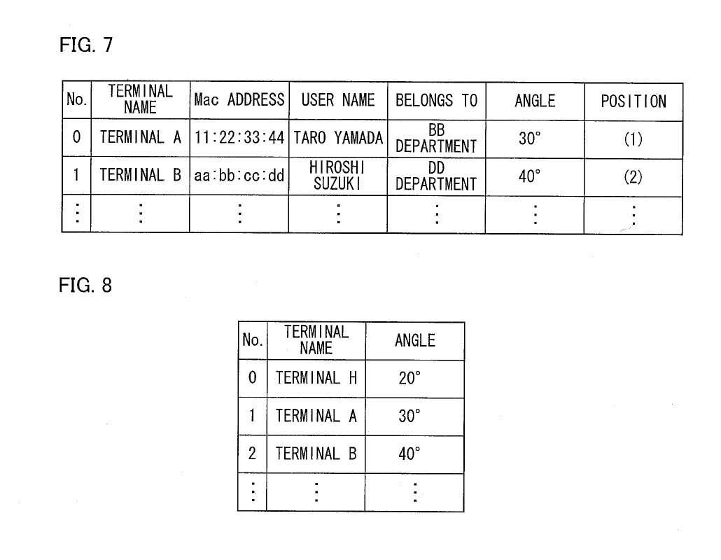

The table of terminal information 16 can be in such an aspect as that shown in FIG. 7. FIG. 7 is a diagram showing an example of a table of terminal information 16. The table of terminal information 16 of FIG. 7 contains seven items of information, namely “NO.”, “TERMINAL NAME”, “Mac ADDRESS (media access control address)”, “USER NAME”, “BELONGS TO”, “ANGLE”, and “POSITION”.

The item “NO.” refers to numbers for managing the terminals 5. These numbers are given to the terminals 5 in the order in which information was added to the table of terminal information 16, i.e., in the order in which the terminals 5 logged in. In the illustrated example, the first number is 0. However, the first number is not limited to 0, but may be 1.

The item “TERMINAL NAME” refers to unique names set for each separate terminal 5, and the item “Mac ADDRESS” refers to numbers for identifying devices connected to the network. Each terminal 5 has its unique Mac address. When a terminal 5 has logged in, the Mac address of that terminal 5 is stored in the table of terminal information 16.

The item “USER NAME” refers to the full names of users (conference participants) who use the terminals 5, and the item “BELONGS TO” refers to departments to which the users belong. The items “USER NAME” and “BELONGS TO” are specified in accordance with the login information inputted at the time of login, and then stored.

Specifically, the full names of conference participants and the departments to which they belong are recorded as a database of correspondence between login IDs and passwords that are assigned to each separate participant, and each participant logs in by inputting his/her login ID and password to the terminal 5. That is, the login ID and the password serve as login information. Then, by using this login information and the database, the full name of the participant who has logged in and the department to which he/she belongs can be specified. The full name and department thus specified are stored in the table of terminal information 16.

It should be noted that the login information needs only be able to be used to identify a participant having logged in, and is not limited to a login ID or a password. For example, in the case of login by an IC card, the login information is various data read out from the IC card. In the case of login by biometric, the login information is data such as fingerprints read at the time of authentication.

The item “ANGLE” refers to the angles of rotation of the imaging device 3 having detected the LEDs 21 of the terminals 5. The item “POSITION” refers to the positions of the seats at which the terminals 5 have been placed, as calculated from the angles stored in the table of terminal information 16. How to calculate the angles and the positions will be described in detail later.

[Details of the Table of Positions 17]

Next, the table of positions 17 is described in detail. The table of positions 17 is a table in which the terminals 5 contained in the table of terminal information 16 are arranged in the order of angles. Use of the table of positions 17 makes it possible to efficiently create a seating chart.

The table of positions 17 can be in such an aspect as that shown in FIG. 8. FIG. 8 is a diagram showing an example of a table of positions 17. As shown in FIG. 8, the table of positions 17 is a table containing the items “NO.”, “TERMINAL NAME”, and “ANGLE”.

The item “NO.” refers to numbers for managing the information stored in the table of positions 17. In the illustrated example, the numbers are given in the order of ascending angles. However, the numbers may be given in the order of descending angles. The items “TERMINAL NAME” and “ANGLE” are read out from the table of terminal information 16 and stored. The table of positions 17 is created with reference to the table of terminal information 16 in displaying a seating chart.

[Arrangement of Seats and Seat Position Information 18]

The server 1 determines who is sitting in which one of a plurality of seats in a predetermined arrangement. That is, the server 1 has a predetermined arrangement of seats set in advance therein, and determines the seat position of each participant in accordance with the arrangement.

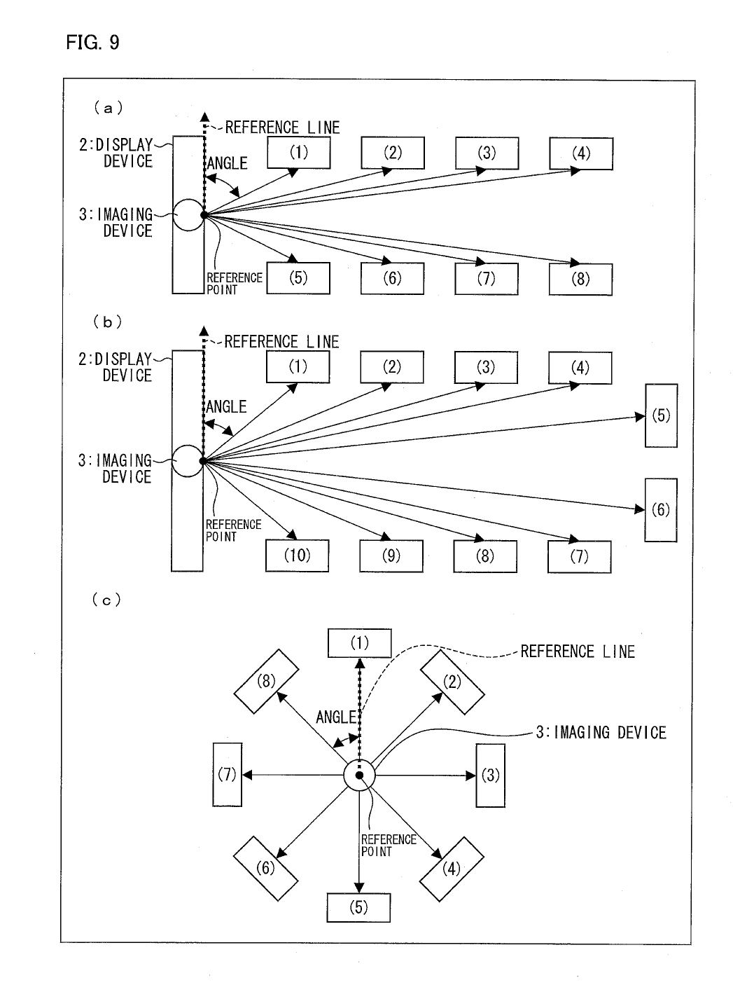

Example arrangements of seats are described below with reference to FIG. 9. FIG. 9 is a set of diagrams (a) to (c) showing example arrangements of seats, (a) of FIG. 9 showing an example of a dual-row arrangement where two rows of seats are arranged in a direction perpendicular to the display surface of the display device 2, (b) of FIG. 9 showing an example of a U-shaped arrangement where a row parallel to the display surface is provided in addition to the two rows of seats, (c) of FIG. 9 showing an example of a circular arrangement where seats are arranged in a circle. It should be noted that (a) to (c) of FIG. 9 are overhead views of the display device 2 and the seats.

In the example shown in (a) of FIG. 9, the seats (1) to (4) are arranged in a direction perpendicular to the display surface of the display device 2 on the right as one faces the display surface, and the seats (5) to (8) are arranged in a direction perpendicular to the display surface of the display device 2 on the left as one faces the display surface. It should be noted that the front of the seats (1) to (4) faces downward in (a) of FIG. 9, and the front of the seats (5) to (8) faces upward in (a) of FIG. 9. That is, those participants sitting in the seats (1) to (4) and those participants sitting in the seats (5) to (8) face each other.

Further, (a) of FIG. 9 shows line segments connecting the imaging device 3 with the seats (1) to (8), respectively. Each of these line segments indicates the orientation of the imaging device 3 rotated so that each seat comes into the imaging region (i.e., the direction of each seat with respect to the imaging device 3). Furthermore, (a) of FIG. 9 shows a reference point at the position of the axis of rotation of the imaging device 3 and a reference line extending from the reference point toward the right as one faces the display device 2.

As shown in (a) of FIG. 9, the imaging device 3 is placed in a position where each seat can be identified by the angle of rotation from the reference line, i.e., in such a position that the line segments connecting the reference point to the respective seats (1) to (8) do not overlap other than at the reference point. For this reason, the angle between the reference line and each segment takes on a different value, and use of this angle makes it possible to determine the position of each seat.

The seat position information 18 indicates correspondence between an angle of rotation from the reference line by which the imaging device is rotated so that each seat comes into the imaging region of the imaging device and a seat position corresponding to that angle of rotation. Each of the seats is provided with a terminal 5. Therefore, by measuring an angle between a line segment connecting the reference point with the terminal 5 (or, more accurately, the LED 21) and the reference line and using the angle thus measured and the seat position information 18, which of the seats the terminal 5 has been placed at can be determined.

It should be noted that for higher consistency with an angle at which the LED 21 is detected, it is preferable that each angle of the seat position information 18 be calculated so that the center of the imaging region of the imaging device comes into a position (e.g., in the vicinity of the central part of the seat) where the LED 21 will come when the terminal 5 is placed at the seat.

In the case of the U-shaped arrangement shown in (b) of FIG. 9 and in the case of the circular arrangement shown in (c) of FIG. 9, too, as in the case of the two-row arrangement shown in (a) of FIG. 9, the position of each seat can be determined by an angle by using a reference point and a segment line.

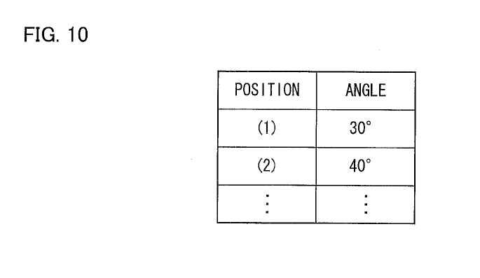

The seat position information 18 thus created may be such a table as that shown in FIG. 10, for example. FIG. 10 is a diagram showing an example of seat position information 18. The seat position information 18 shown in FIG. 10 indicates correspondence between numbers indicating the positions of seats and angles of rotation by which the imaging device 3 are rotated so that the seats comes into the imaging region. It should be noted that the numbers indicating the positions of the seats in FIG. 10 correspond to the numbers given to the seating chart of FIG. 9.

For this reason, use of the seat position information 18 shown in FIG. 10 makes it possible to determine, from an angle of rotation by which the imaging device 3 is rotated so that a lighted LED 21 comes into the imaging region, the position of a seat provided with a terminal 5 including that LED 21.

It should be noted that the seat position information 18 needs only indicate, for a plurality of seat positions as candidate seat positions in which a terminal 5 is placed, in which direction each seat position is located with respect to the device detecting the LED 21, and is not limited to the illustrated example. For example, in a case where a detection device for detecting an LED 21 is provided separately, as compared with the case of the present embodiment where detection of an LED 21 is carried out by the imaging device 3, the seat position information 18 is information indicating in which direction each seat position is located with respect to the detection device.

Further, since images of seating charts such as those shown in FIG. 9 indicate in which direction each seat position is located with respect to the imaging device 3, the seat position can also be determined by using such an image as a template.

That is, an image such as those shown in FIG. 9 is stored in advance as a seating chart template, and on the seating chart template, a seat located in a direction indicated by an angle at which a lighted LED 21 has been detected is determined with respect to the reference point. This makes it possible to determine a seat provided with a terminal 5 including a lighted LED 21.

[Measurement of Angle by the Imaging Device 3]

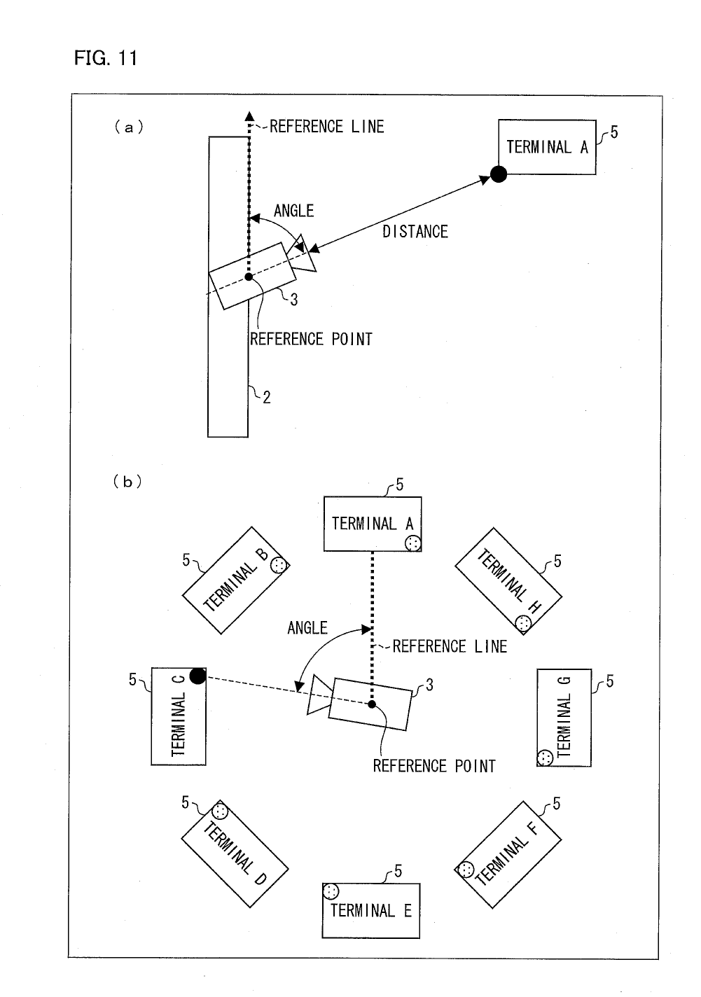

Next, a method for measuring an angle to be stored in the table of terminal information 16 and the table of positions 17, i.e., for measuring an angle of rotation of the imaging device 3 having detected a lighted LED 21 is described with reference to FIG. 11. FIG. 11 is a set of diagrams (a) and (b) each explaining a method for measuring an angle at which a lighted LED 21 has been detected, (a) of FIG. 9 showing a measuring method that is employed in a case where the seats are not arranged in a circle, (b) of FIG. 9 showing a measuring method that is employed in a case where the seats are arranged in a circle. It should be noted that (a) and (b) of FIG. 11 are overhead views of the display device 2, the imaging device 3, the terminals 5, and the like. Further, for simplicity, (a) of FIG. 11 illustrates only one terminal 5 (terminal A alone).

As with an angle of a seat position, an angle at which a lighted LED 21 has been detected is one obtained by calculating an angle of rotation of the imaging device 3 with use of a reference point and a reference line. It should be noted that the reference point for calculation of an angle at which a lighted LED 21 has been detected is set in the same position as an angle of a seat position is calculated, and the reference line is set in the same direction as an angle of a seat position is calculated.

For measurement of an angle, the imaging device 3 is horizontally rotated so that a lighted LED 21 comes into the center of an image that is taken by the imaging device 3. Then, the angle of rotation from the reference line at which the lighted LED 21 has come into the center of the image is calculated. This angle is an angle which indicates the position of the terminal 5 and which is stored in the table of terminal information 16 and the table of positions 17.

How to calculate an angle in the case of the circular arrangement shown in (b) of FIG. 11 is the same as in the case of (a) of FIG. 11. That is, the same reference point and the same reference line are set as when an angle of a seat position is calculated, an angle of rotation from the reference line at which a lighted LED 21 has come into the center of an image that is taken by the imaging device 3 is calculated.

The process of rotating the imaging device 3 so that a lighted LED 21 comes into the center of an image that is taken by the imaging device 3 is automatically carried out by the imaging device control section 12. Since the technique of automatically searching for and taking an image of a predetermined object (a lighted LED 21, in this case) is publicly known, and as such, is not described here. It should be noted that the process of rotating the imaging device 3 may be carried out by a user's operation.

Further, in a case where the imaging device 3 has an autofocusing function, this function can be used to measure the distance from the imaging device 3 to a terminal 5 (or, more accurately, an LED 21). By measuring the distance from the imaging device 3 to a terminal 5, each terminal can be identified even in a case where a plurality of terminals 5 are placed in a straight line extending from the reference point.

[Flow of a Process that is Executed by the Server 1]

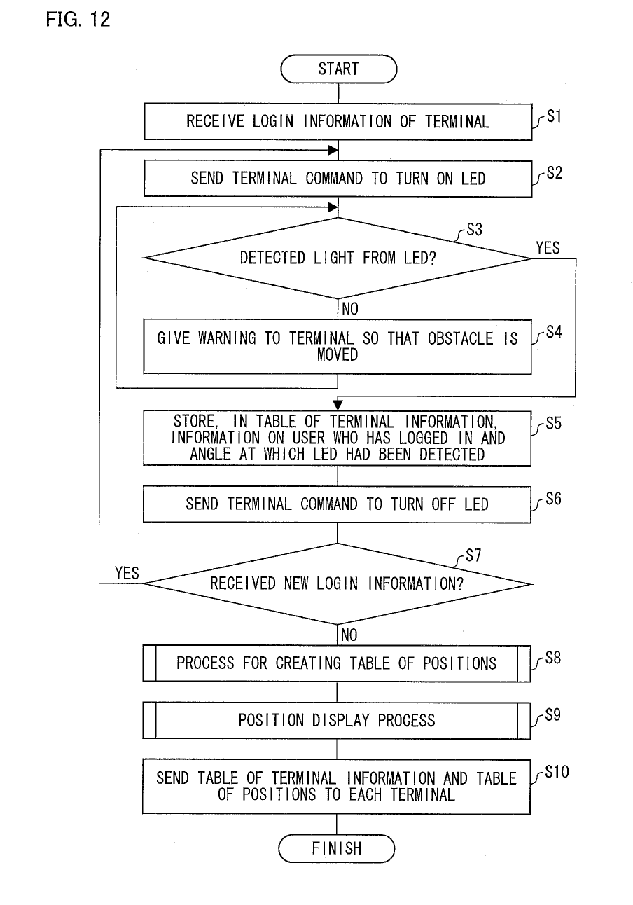

The flow of a process that is executed by the server 1 is described with reference to FIG. 12. FIG. 12 is a flow chart showing an example of a process that is executed by the server 1.

When a user of a terminal 5 logs in, the position determining section 26 of the terminal 5 sends login information to the server 1. The login information is received by the position determining section 13 via the communication I/F 14 (S1). Next, the position determining section 13 sends, via the communication I/F 14 to the terminal 5 from which the login information was sent, a command to turn on the LED 21 (S2).

Further, the position determining section 13 instructs the imaging device control section 12 to cause the imaging device 3 to detect the LED 21 thus turned on. Then, after the instruction, the position determining section 13 confirms with the imaging device control section 12 whether or not the LED 21 thus turned on has been detected (S3).

If detection of the LED 21 thus turned on has not been confirmed within a certain period of time (NO in S3), the position determining section 13 sends a command to the logged-in terminal 5 via the communication I/F 14 so that the terminal 5 gives a warning that an obstacle should be moved so that the LED 21 can be seen from the imaging device 3 (S4). Then, when a certain period of time has elapsed since the warning was given, the position determining section 13 confirms again whether or not the LED 21 thus turned on has been detected (S3).

It should be noted that the warning needs only be such that a participant using the logged-in terminal 5 (participant using that terminal 5) can recognize that the imaging device 3 has failed to detect the terminal 5. For example, such a message as to prompt the participant to move the terminal 5 may be displayed as follows: “Move the terminal to a such a position that the LED can be seen from the imaging device”, or “Move the obstacle so that the LED can be seen from the imaging device”. Such a message may be outputted as an audio warning.

On the other hand, if detection of the LED 21 thus turned on has been confirmed (YES in S3), the position determining section 13 acquires, from the imaging device control section 12, an angle of the imaging device 3 at which the LED 21 thus turned on has been detected. It should be noted that as explained with reference to FIG. 11, the angle is an angle by which the imaging device 3 has rotated from the reference line.

Further, the position determining section 13 determines, from the login information received in S1, the participant who has logged into the terminal 5, and acquires information on the participant (his/her full name and the department to which he/she belongs). Then, the position determining section stores, in the table of terminal information 16, the acquired angle and the acquired information on the participant (S5).

Next, the position determining section 13 sends a command to the logged-in terminal 5 via the communication I/F 14 so that the terminal 5 turns off the LED 21 (S6). Further, the position determining section 13 confirms whether or not new login information has been received (S7).

If reception of new login information has been confirmed (YES in S7), the position determining section 13 causes the logged-in terminal 5 to turn on its LED 21 (S2) and acquires an angle of the terminal 5. Then, the position determining section 13 stores the acquired angle in the table of terminal information 16 together with information on the participant using the terminal 5, and causes the terminal 5 to turn off its LED 21 (S3 to S6).

On the other hand, if reception of new login information has not been confirmed (NO in S7), the position determining section 13 carries out a process for creating a table of positions, thereby creating a table of positions 17 (S8). It should be noted that the process for creating a table of positions will be described later in detail.

Then, the position determining section 13 carries out a position display process (S9). This causes the display device 2 to display a seating chart showing the placement of a participant of each terminal 5. Further, the position determining section 13 sends the table of terminal information 16 and the table of positions 17 to the terminal 5 via the communication I/F 14 (S10), whereby the server 1 finishes its process.

Then, upon receiving the table of terminal information 16 and the table of positions 17, the terminal 5 carries out a position display process (terminal) by using the tables thus received, whereby the display section 20 of the terminal 5 also display a seating chart. It should be noted that the process for creating a table of positions, the position display process, and the position display process (terminal) will be described later in detail.

(Flow of the Process for Creating a Table of Positions)

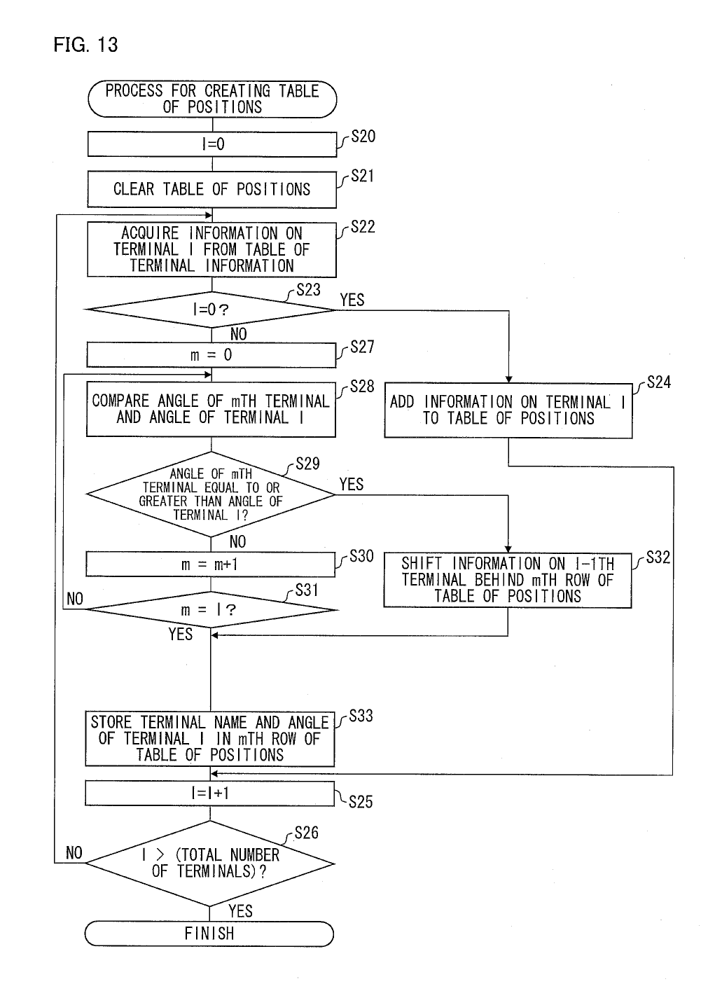

Next, the process for creating a table of positions as carried out in S8 of FIG. 12 is described in detail with reference to FIG. 13. FIG. 13 is a flow chart showing an example of a process for creating a table of positions.

First, the position determining section 13 configures the settings so that I=0 (S20), and clears (initializes) the table of positions 17 (S21). Then, the position determining section 13 acquires information on a terminal I (terminal 5 whose number is “I”) from the table of terminal information 16 (S22). That is, I is a numerical value for identifying a terminal 5 in the table of terminal information 16. It should be noted that the information acquired from the table of terminal information 16 is information for creating the table of positions 17, i.e., is specifically a terminal name and an angle.

Then, the position determining section 13 confirms whether or not I=0 (S23). If the position determining section 13 has confirmed here that I=0 (YES in S23), the position determining section 13 adds the information on the terminal I to the table of positions (S24) to increments the value of I by 1 so that I=I+1 (S25).

Next, the position determining section 13 confirms whether or not the value of I thus incremented exceeds the total number of terminals 5 (S26). It should be noted that the total number of terminals 5 is the total number of terminals 5 whose information has been stored in the table of terminal information 16. If the position determining section 13 has confirmed here that the value of I exceeds the total number of terminals 5 (YES in S26), the position determining section 13 judges that all the terminal 5 whose information has been stored in the table of terminal information 16 have been added to the table of positions 17, and finishes the process for creating a table of positions.

On the other hand, if the position determining section 13 has confirmed that the value of I is equal to or less than the total number of terminals 5 (NO in S26), the position determining section 13 acquires the information on the terminal I from the table of terminal information 16 (S22), and confirms whether I=0 (S23). It should be noted here that because I≧1 since the value of I was incremented by 1 in S15, the position determining section 13 confirms that I≠0 (NO in S23).

Next, the position determining section 13 sets m to 0 (S27), where m is a numerical value for identifying a terminal in the table of positions 17. Then, the position determining section 13 compares the angle of the terminal I with the angle of the terminal 5 (whose number is “m”) as stored in the mth row of the table of positions 17 (S28), and confirms whether or not the angle of the mth terminal 5 is equal to or less than the angle of the terminal I (S29).

If the position determining section 13 has confirmed that the angle of the mth terminal 5 is equal to or greater than the angle of the terminal I (YES in S29), the position determining section 13 shifts the storage position of information on the I−1th terminal 5 by one behind (toward greater angles) from the mth row of the table of positions 17 (S32), and stores the terminal name and angle of the terminal I in the mth row (S33).

On the other hand, if the position determining section 13 has confirmed that the angle of the mth terminal 5 is less than the angle of the terminal I (NO in S29), the position determining section 13 increments the value of m by 1 so that m=m+1 (S30), and confirms whether or not the value of m thus incremented matches the value of I (S31).

If the position determining section 13 has confirmed here that the value of m does not match the value of I (NO in S31), the position determining section 13 makes a comparison between the angle of the terminal 5 as stored in the mth row of the table of positions 17 and the angle of I (S28), and confirms whether or not the angle of the mth terminal 5 is equal to or less than the angle of the terminal I.

On the other hand, if the position determining section 13 has confirmed in S31 that the value of m matches the value of I (YES in S31), the position determining section 13 stores the terminal name and angle of the terminal I in the mth row of the table of positions 17 (S33).

After S33, the position determining section 13 increments I by 1 (S25). Then, until the position determining section 13 confirms in S26 that I exceeds the total number of terminals 5, the position determining section 13 carries out the steps S22 to S33 and S25 to S26. With these steps, the table of positions 17 is created in which the terminals 5 stored in the table of terminal information 16 are arranged in the order of their angles.

[Flow of the Position Display Process]

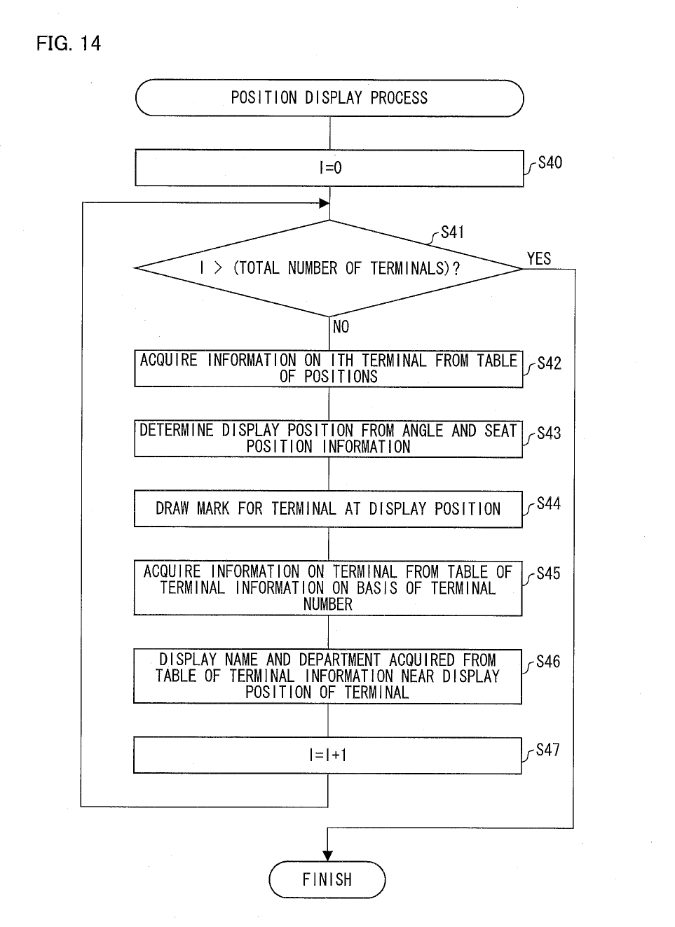

Next, the position display process that is carried out in S9 of FIG. 12 is described in detail with reference to FIG. 14. FIG. 14 is a flow chart showing an example of a position display process. As mentioned above, the position display process is a process for causing the display device 2 to display a seating chart.

First, the position determining section 13 sets I to 0 (S40), where I is a numerical value for identifying a terminal 5 in the table of positions 17. Next, the position determining section 13 confirms whether or not the value of I exceeds the total number of terminals 5 (S41). It should be noted that the total number of terminals 5 is the total number of terminals 5 whose information has been stored in the table of positions 17.

Since the settings have been configured in S40 so that I=0, the position determining section 13 judges that the value of I is equal to or less than the total number of terminals 5 (NO in S41), and acquires information on the Ith terminal 5 from the table of positions 17 (S42). It should be noted that the information on the terminal 5 that is acquired here is a terminal name and an angle.

Next, the position determining section 13 determines the position of the Ith terminal 5 by using the angle acquired in S42 and the seat position information 18 stored in the memory section 15 (S43). Specifically, the position determining section 13 chooses, from among the angles contained in the seat position information 18, the closest angle to the angle acquired in S42, and determines a position corresponding to that angle as the position of the Ith terminal 5. Then, the position determining section 13 sends the display processing section 11 the position determined in S43 and the terminal name of the terminal 5 whose position has been determined. Further, the position determining section 13 stores, in the table of terminal information 16, information indicating the position thus determined (“POSITION” of FIG. 7).

Upon receiving the position and the terminal name, the display processing section 11 causes the display device 2 to display an image of a seating chart yet to show the names of the participants or the like and showing only the positions of the seats. This image is one stored in advance in the memory section 15 or the like, and may be such an image as those shown in FIG. 9.

Then, the display processing section 11 draws, on the seating chart thus displayed, a mark for a terminal 5 on a seat indicated by the position received from the position determining section 13 (S44). It should be noted the mark to be drawn here needs only be such that the presence of a participant sitting in the seat can be recognized.

Next, the display processing section 11 acquires, from the table of terminal information 16, information on the terminal 5 corresponding to the terminal name received (S45). It should be noted here that the full name and the department are acquired as information on the terminal 5.

Then, the display processing section 11 displays, on the seating chart displayed on the display device 2, the full name and the department acquired from the table of terminal information 16 in S45, in such a manner that the full name and the department are displayed near the position where the mark for the terminal 5 has been displayed (S46). Further, the display processing section 11 notifies the position determining section 13 of completion of the display of the seating chart.

Upon receiving this notification, the position determining section 13 increments the value of I by 1 so that I=I+1 (S47), and returns to the step S41. It should be noted that the steps S41 to S47 are repeated until it is judged that I exceeds the total number of terminals 5 (YES in S41), whereby the display device 2 displays a seating chart containing participants at all the terminals 5 contained in the table of positions 17.

[Examples of Images that are Displayed on the Display Device 2]

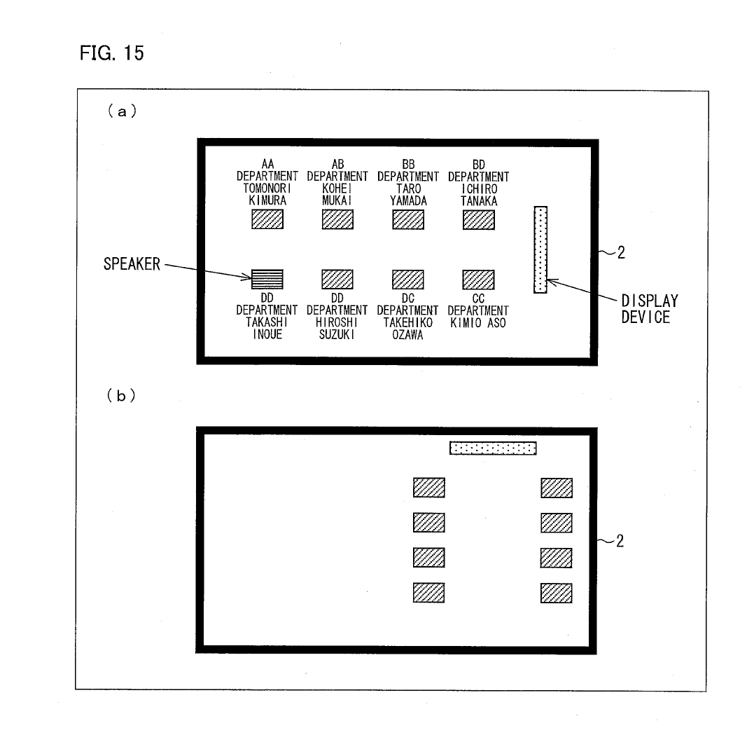

A seating chart that is displayed on the display device 2 by the aforementioned position display process looks like those shown in FIG. 15, for example. FIG. 15 is a set of diagrams (a) and (b) each showing an example of a seating chart that is displayed by the position display process, (a) of FIG. 15 showing an example of a seating chart displayed so that the display device is on the right side of the seats, (b) of FIG. 15 showing an example of a seating chart displayed so that the display device is on the upper side of the seats. For simplicity, (b) of FIG. 15 omits to illustrate the departments and the full names.

As shown in (a) of FIG. 15, by displaying a seating chart showing who is sitting in which seat, the display device 2 allows each participant in a conference to recognize at one glance who is in the conference and who is seated where. It should be noted that each seat is given a shade drawn by the process of drawing a mark for each terminal 5 in S44 of the position display process of FIG. 14. That is, a seat neither provided with a terminal 5 nor occupied by a participant is displayed as a blank seat. Further, a speaker's seat is marked in such a manner as to be distinguishable from the other seat.

Further, the seating chart to be displayed needs only contain at least the positions of seats and information that allows identifying participants using those seats. For example, it is possible to display only the “surnames” of the participants instead of displaying their full names, display screen names or the like that have been registered in advance, and/or display login information such as login IDs. Moreover, for easier grasping of the positional relationship between the participants, it is preferable that the position of the display device be displayed as in the illustrated examples. Further, it is preferable that information that serves as a reference in process of the conference, such as the departments, be displayed together with the names of the participants.

In the case of a seating chart displayed so that the display device 2 is on the right side of the seats as shown in (a) of FIG. 15, the orientation of an eye line on the seating chart and the orientation of a line of eyes looking at the seating chart are different. This may make the participants unable to smoothly grasp the positional relationship between one seat and another.

For this reason, it is preferable that a seating chart be displayed so that the display device 2 is on the upper side of the seats as shown in (b) of FIG. 15. With this, the orientation of an eye line on the seating chart and the orientation of a line of eyes looking at the seating chart match each other. This allows each participant to smoothly grasp the positional relationship between the seats.

[Flow of the Position Display Process (Terminal)]

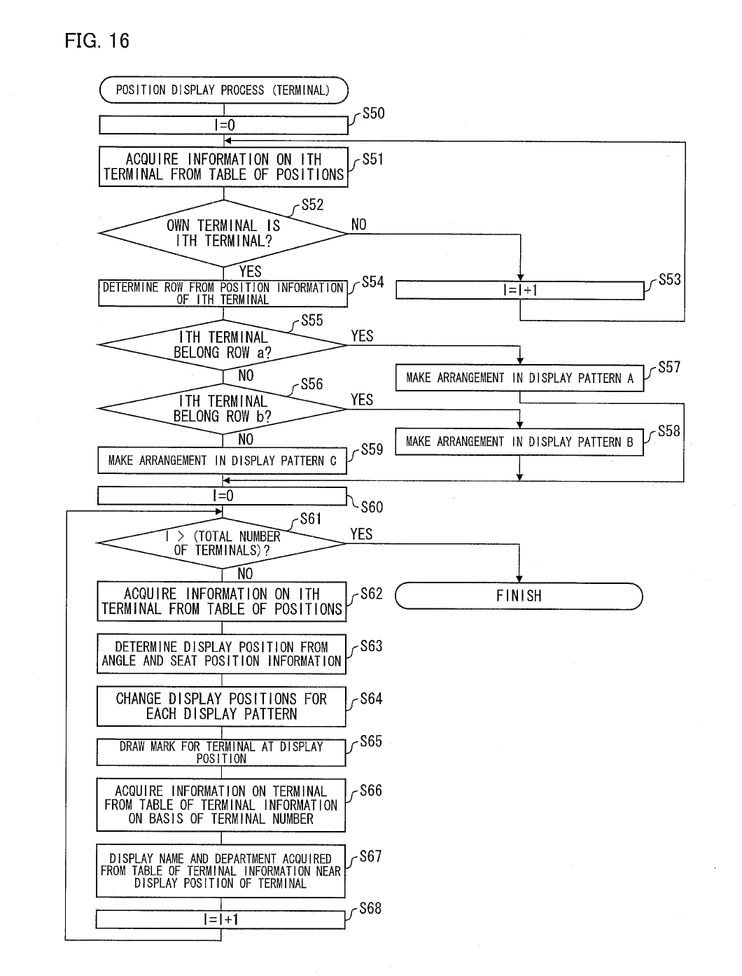

The flow of the position display process (terminal) is described with reference to FIG. 16. FIG. 16 is a flow chart showing an example of a position display process (terminal). It should be noted that the position display process (terminal) is a process that is carried out by a terminal 5 having received the table of terminal information 16 and the table of positions 17 sent from the server 1 in S10 of FIG. 12.

In the position display process (terminal), a seating chart in such an orientation that a participant who uses a terminal 5 for carrying out the position display process (terminal) can easily recognize the positional relationship between the seats is displayed in accordance with the seat at which the terminal 5 has been placed. For this purpose, in the position display process (terminal), a process for determining the position of the seat at which the terminal 5 has been placed is carried out first.

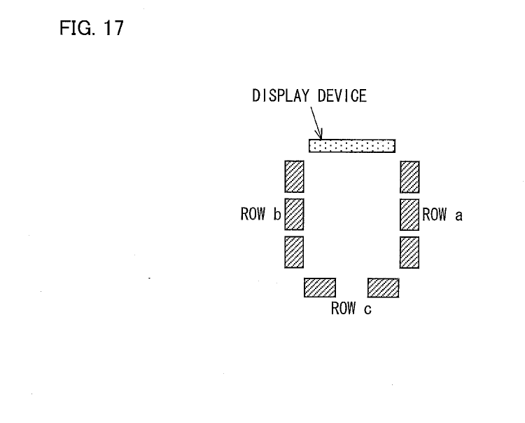

More specifically, the terminal 5 carries out a process for determining which of the rows a to c in the arrangement shown in FIG. 17 the terminal 5 belongs to. FIG. 17 is a diagram that classifies a U-shaped arrangement of seats into three rows a to c according to the direction in which the participant sitting in each seat faces.

In the case of a U-shaped arrangement of seats as shown in FIG. 17, the frontward direction in which each participant is facing varies according to the position of his/her seat. That is, the row b is in front of those participants seated in the row a, and the row a is in front of those participants seated in the row b. Further, the display device 2 is in front of those participants seated in the row c.

By displaying a seating chart so that the front faces upward, it can be made easier for the participants to grasp the positional relationship between one seat and another. For this purpose, the position display process (terminal) determines which of the rows a to c the terminal 5 belongs to.

First, the position determining section 26 configures the settings so that I=0 (S50), and acquires the Ith information from the table of positions 29 received from the server 1 and stored in the memory section 15 (as obtained by receiving the table of positions 17 from the server 1 and storing it in the memory section 27) (S51). It should be noted here that the information that is acquired from the table of positions 29 is a terminal name.

Next, the position determining section 26 confirms whether its corresponding terminal is the Ith terminal, i.e., whether its corresponding terminal is a terminal 5 identified by the terminal name acquired from the table of positions 29 (S52). If its corresponding terminal is not the Ith terminal here (NO in S52), the position determining section 26 increments the value of I by 1 so that I=I+1 (S53), and returns to the step S51. The position determining section 26 repeats the steps S51 to S53 until it confirms that its corresponding terminal is the Ith terminal (YES in S52).

Then, when the position determining section 26 has confirmed that its corresponding terminal is the Ith terminal, the position determining section 26 reads out the “angle” of the Ith terminal 5 from the table of positions 29, determines the position of its corresponding terminal by collating the “angle” thus read out and the seat position information 30, and determines, from the position, which of the rows a to c its corresponding terminal belongs to (S54). Let it be assumed that correspondence between the seat positions and the rows has been stored in advance. Further, the seat position information 30 may be acquired by causing the server 1 to send the seat position information 18, or may be stored in advance in the memory section 27.

Then, the position determining section 26 confirms whether the Ith terminal 5, i.e., its corresponding terminal belongs either or neither of the rows a and b (S55, S56). If the position determining section 26 has confirmed here that the Ith terminal 5 belongs to the row a (YES in S55), the position determining section 26 decides to make an arrangement in a display pattern A (S57), and proceeds to the step S60. On the other hand, if the position determining section 26 has confirmed here that the Ith terminal 5 belongs to the row b (NO in S55, YES in S56), the position determining section 26 decides to make an arrangement in a display pattern B (S58), and proceeds to the step S60. Alternatively, the position determining section 26 has confirmed here that the Ith terminal 5 belongs to neither the row a nor b (NO in S55, NO in S56), the position determining section 26 decides to make an arrangement in a display pattern C (S59), and proceeds to the step S60.

It should be noted that the steps S51 to S59 may be carried out by using the table of terminal information 28 (as obtained by receiving the table of terminal information 16 from the server 1 and storing it in the memory section 27). In this case, the position determining section 26 acquires the Ith information from the table of terminal information 28 in S51, and determines, in S54, from the “position” read out from the table of terminal information 28, to which row its corresponding terminal belongs.

Thus, according to the flow chart of FIG. 16, if the position determining section 26 has confirmed that the Ith terminal 5 belongs to neither the row a nor b, the position determining section 26 decides to make an arrangement in the display pattern C, which corresponds to the row c. For this reason, the process of this flow chart can be applied to a two-row arrangement of the rows a and b only, as well as a U-shaped arrangement of all the rows a to c.

It should be noted that the display pattern A is a display pattern of a seating chart in which the row b, the display device 2, and the row a are displayed on the upper side, the right side, and the lower side, respectively, so that those participants seated in the row a can easily see the seating chart. The display pattern B is a display pattern of a seating chart in which the row a, the display device 2, and the row b are displayed on the upper side, the left side, and the lower side, respectively, so that those participants seated in the row b can easily see the seating chart. The display pattern C is a display pattern of a seating chart in which the row a, the display device 2, the row b, and the row c are displayed on the right side, the upper side, the left side, and the lower side, respectively, so that those participants seated in the row c can easily see the seating chart.

In S60, the position determining section 26 configures the settings so that I=0, and then confirms whether or not I exceeds the total number of terminals (S61). It should be noted that the total number of terminals is the total number of terminals whose information has been stored in the table of positions 29.

Since the settings have been configured in S60 so that I=0, the position determining section 26 judges that the value of I is equal to or less than the total number of terminals (NO in S61), and acquires information on the Ith terminal from the table of positions 29 (S62). It should be noted that the information on the terminal that is acquired here is a terminal name and an angle. Next, the position determining section 26 determines the position of the Ith terminal by using the angle acquired in S62 and the seat position information 30 stored in the memory section 27 (S63).

The position determining section 26 changes, in accordance with the display pattern determined in the steps S55 to S59, the display positions determined in S63 (S64). Specifically, in the case of the display pattern A, the position determining section 26 determines the orientation of the seating chart so that the row b, the display device 2, and the row a are displayed on the upper side, the right side, and the lower side, respectively. Similarly, in the case of the display pattern B, the position determining section 26 determines the orientation of the seating chart so that the row a, the display device 2, and the row b are displayed on the upper side, the left side, and the lower side, respectively. In the case of the display pattern C, the position determining section 26 determines the orientation of the seating chart so that the row a, the display device 2, the row b, and the row c are displayed on the right side, the upper side, the left side, and the lower side, respectively.

Then, the position determining section 26 instructs the display processing section 24 to display the terminal on the seating chart oriented as determined in S64. Upon receiving the instruction, the display processing section 24 draws the seating chart in the orientation determined in S64 and further draws a mark for the terminal 5 in that position on the seating chart which has been determined in S63 (S65), and causes the display section 20 to display the image thus drawn. Next, the display processing section 24 acquires information on the terminal from the table of terminal information 28 (S66). In this case, a name and a department are acquired as the information on the terminal.

Then, the display processing section 24 displays the full name and the department acquired from the table of terminal information 28 in S66, in such a manner that the full name and the department are displayed near the position where the mark for the terminal 5 has been displayed (S67). Further, the display processing section 24 notifies the position determining section 26 of completion of the display of the mark for and the information on the terminal 5.

Upon receiving this notification, the position determining section 26 increments the value of I by 1 so that I=I+1 (S68), and returns to the step S61. It should be noted that the steps S61 to S68 are repeated until it is judged that I exceeds the total number of terminals 5 (YES in S61), whereby the display section 20 displays a seating chart reflecting all the terminals contained in the table of positions 29.

In the example shown in FIG. 16, the display position is calculated from the angle and the seat position information 30 in S63. However, in a case where position information is contained in advance in the table of terminal information 28 as in the example shown in FIG. 7, the display position can be determined by using the position information.

Further, the present embodiment has shown a case where by sending the table of terminal information 16 and the table of positions 17 from the server 1 to a terminal 5 and carrying out the position display process (terminal) at the terminal 5 having received the table of terminal information 16 and the table of positions 17, the display section 20 is made to display a seating chart.

However, a configuration for causing the display section 20 of a terminal 5 to display a seating chart is not limited to this example. For example, an image that is displayed on the display device 2 by the position display process that is carried out by the server 1 may be sent to the terminal 5, for example, by the position determining section 13 of the server 1 so that the display section 20 displays the image. In this case, the display processing section 24 of the terminal 5 needs only cause the image thus received to be displayed, and the position determining section 26 no longer needs to carry out the position display process (terminal).

[Examples of Images that are Displayed on the Display Section 20]

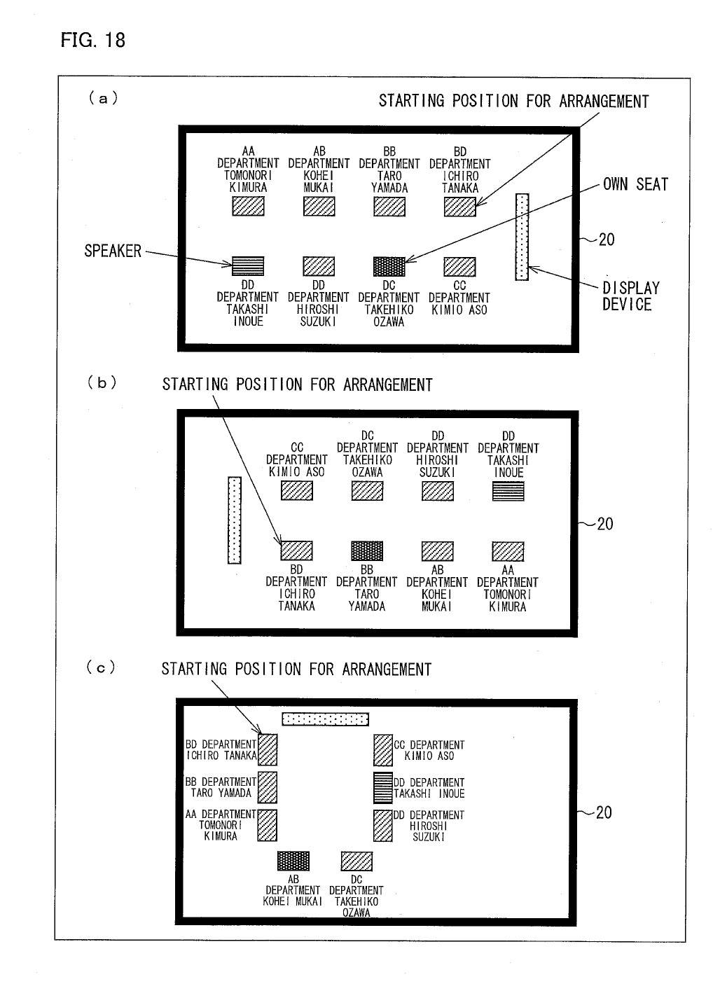

A seating chart that is displayed on the display section 20 by the aforementioned position display process (terminal) looks like those shown in FIG. 18, for example. FIG. 18 is a set of diagrams (a) to (c) each showing an example of a seating chart that is displayed by the position display process (terminal).

(a) of FIG. 18 shows an example of an image in the display pattern A or, more specifically, shows an example of an image that is displayed on the display section 20 of Mr. Takehiko Ozawa's terminal 5. By orienting a seating chart so that the front of the row a faces upward on the seating chart, the actual direction as seen from those participants seated in the row a and the direction of the seating chart as seen by the participants can be matched. This makes it easier for each participant to recognize who is sitting in which seat. That is, in the illustrated example, Mr. Takehiko Ozawa can easily recognize that Mr. Taro Yamada is sitting in front of him, that Mr. Kimio Aso is sitting on his right hand, and that Mr. Hiroshi Suzuki is sitting on his left hand.

In (a) of FIG. 18, a speaker's seat is displayed with a mark so that a participant who is speaking (speaker) can be distinguished. Marking of a speaker's seat is not an essential configuration. However, such a configuration allows the other participants to easily recognize in which seat the speaker is sitting. Therefore, it is preferable that a speaker's seat be marked.

Further, (a) of FIG. 18 shows a starting position for arrangement. Since it is assumed here that the table of positions 29, in which the terminals are arranged in the order of ascending angles, is used, the arrangement gets started from Mr. Ichiro Tanaka's terminal, which is at the smallest angle to the reference position.

(b) of FIG. 18 shows an example of an image in the display pattern B or, more specifically, shows an example of an image that is displayed on the display section 20 of Mr. Taro Yamada's terminal 5. By orienting a seating chart so that the front of the row b faces upward on the seating chart, the actual direction as seen from those participants seated in the row b and the direction of the seating chart as seen by the participants can be matched. That is, in the illustrated example, Mr. Taro Yamada can easily recognize that Mr. Takehiko Ozawa is sitting in front of him, that Mr. Kohei Mukai is sitting on his right hand, and that Mr. Ichiro Tanaka is sitting on his left hand.

(c) of FIG. 18 shows an example of an image in the display pattern C or, more specifically, shows an example of an image that is displayed on the display section 20 of Mr. Kohei Mukai's terminal 5. By orienting a seating chart so that the front of the row c faces upward on the seating chart, the actual direction as seen from those participants seated in the row c and the direction of the seating chart as seen by the participants can be matched. That is, in the illustrated example, Mr. Kohei Mukai can easily recognize that Mr. Takehiko Ozawa is sitting on his right hand.

[Flow of the Position Display Process (Terminal) in the Case of a Circular Arrangement of Seats]

The position display process (terminal) in the case of a two-row arrangement of seats or a U-shaped arrangement of seats has been described with reference to FIGS. 16 through 18. In the case of a circular arrangement of seats, however, there is no more distinction between the row a, the row b, the row c, etc. This means a slight change in content of the position display process (terminal).

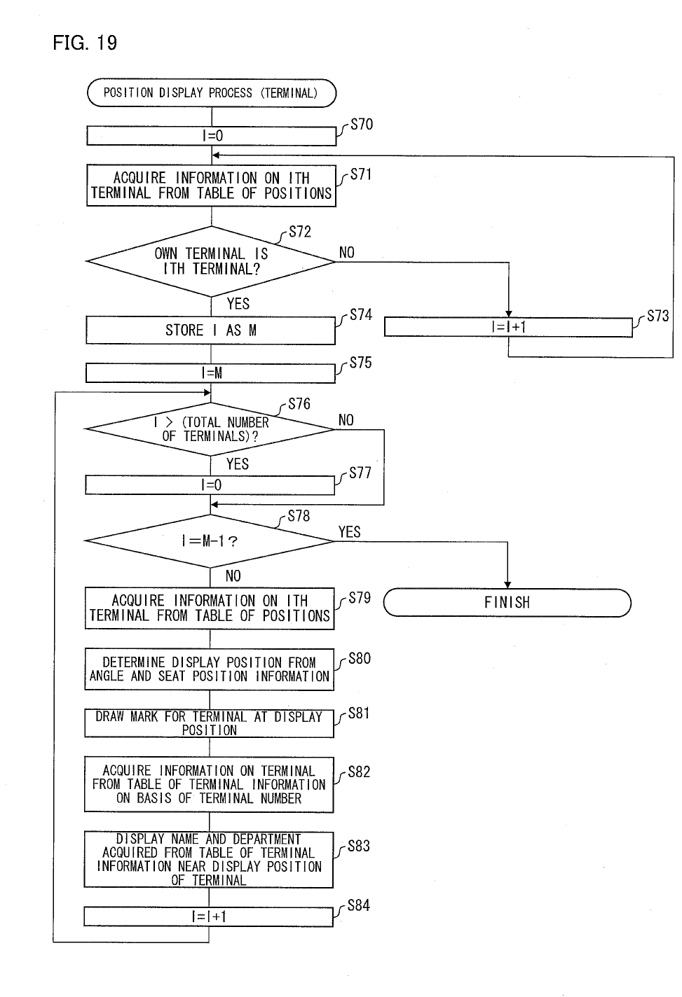

The flow of the position display process (terminal) in the case of a circular arrangement of seats is described here with reference to FIG. 19. FIG. 19 is a flow chart showing an example of a position display process (terminal) in the case of a circular arrangement of seats. It should be noted that the settings have been configured in advance for each terminal 5 as to whether or not the seats are arranged in a circle, the position display process (terminal) as shown in FIG. 16 or FIG. 18 is carried out on the basis of the settings.

First, the position determining section 26 carries out the steps S70 to S73 in order to determine in what place on the table of positions 29 its corresponding terminal is positioned. It should be noted that the steps S70 to S73 are identical to the steps S50 to S53 of FIG. 16, and as such, are not described here.

When the position determining section 26 has determined that its corresponding terminal is positioned in Ith place (YES in S72), the position determining section 26 stores the value of I as the value of M (S74). It should be noted that M is a numerical value for confirming whether or not all the terminals contained in the table of positions 29 have been arranged.

Next, the position determining section 26 configures the settings so that I=M (S75), and confirms whether or not the I exceeds the total number of terminals (S76). It should be noted that the total number of terminals is the total number of terminals contained in the table of positions 29.

Since the settings have been configured in S75 so that I=M, the position determining section 26 confirms that I does not exceed the total number of terminals (NO in S76), and proceeds to the step S78. It should be noted that if the position determining section 26 has confirmed that I exceeds the total number of terminals, the position determining section 26 configures the settings so that I=0 (S77), and proceeds to the step S78.

Then, in S78, the position determining section 26 confirms whether or not I is equal to M−1. Since the settings have been configured in S75 so that I=M, the position determining section 26 confirms that I is not equal to M−1 (NO in S78), and proceeds to the step S79. It should be noted that if the position determining section 26 has confirmed that I is equal to M−1, i.e., if all the terminals from I=M to I=M−1 have been arranged, the position determining section 26 finishes the position display process (terminal).

In S79, the position determining section 26 acquires information on the Ith terminal from the table of positions 29. It should be noted that the information on the terminal that is acquired here is a terminal name and an angle. Then, the position determining section 26 determines the position of the Ith terminal by using the angle acquired in S79 and the seat position information 30 stored in the memory section 27 (S80), and sends the display processing section 24 an instruction to display a seating chart.

Upon receiving the display instruction, the display processing section 24 draws a seating chart of a circular arrangement in such an orientation that the seat position of its corresponding terminal is on the lowermost side of the screen and further draws a mark for the terminal 5 in the seat position on the seating chart which has been determined in S80 (S81), and causes the display section 20 to display the image thus drawn. Next, the display processing section 24 acquires information on the terminal from the table of terminal information 28 (S82). In this case, a name and a department are acquired as the information on the terminal.

Then, the display processing section 24 displays the full name and the department acquired from the table of terminal information 28 in S82, in such a manner that the full name and the department are displayed near the position where the mark for the terminal 5 has been displayed (S83). Further, the display processing section 24 notifies the position determining section 26 of completion of the display of the mark for and the information on the terminal.

Upon receiving this notification, the position determining section 26 increments the value of I by 1 so that I=I+1 (S84), and returns to the step S76. It should be noted that the steps S76 to S84 are repeated until it is judged YES in S78, whereby a seating chart reflecting all the terminals from I=M to I=M−1 is displayed.

Further, in the position display process (terminal) of FIG. 19, the seating chart is displayed in such an orientation that the seat at which the Mth terminal, i.e., the corresponding terminal has been placed comes undermost on the screen. This causes the front of the seat to face upward on the seating chart. Therefore, for a participant who looks at a seating chart displayed on the display section 20 of a terminal 5, it becomes easier to recognize the positional relationship with the other participants.

[Example of an Image that is Displayed on the Display Section 20]

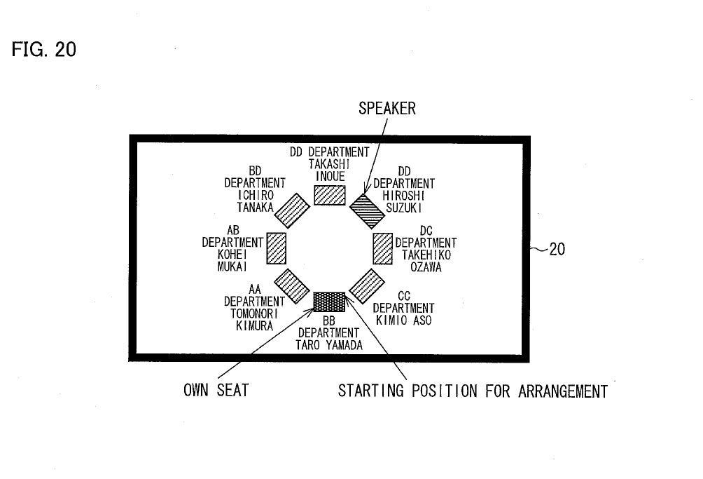

A seating chart that is displayed on the display section 20 by the aforementioned position display process (terminal) looks like that shown in FIG. 20, for example. FIG. 20 is a diagram showing an example of a seating chart that is displayed by a position display process (terminal) in the case of a circular arrangement of seats.

As shown in FIG. 20, by displaying a seating chart so that the seat occupied by a participant who uses his/her terminal (his/her seat) comes undermost on the screen, the arrangement of the seats as seen from the participant who uses his/her terminal and the arrangement of the seats on the seating chart thus displayed can be matched. This makes it easier for each participant to recognize the positional relationship between the seats. That is, in the illustrated example, Mr. Taro Yamada can easily recognize that Mr. Takashi Inoue is sitting in front of him, that Mr. Kimio Aso is sitting on his right hand, and that Mr. Tomonori Kimura is sitting on his left hand.

[Modification]

The foregoing embodiment has been described by taking, as an example, a case where each terminal 5 is marked on a seating chart by using the table of positions 17 or 29. However, such marking can be done without using the table of positions 17 or 29. In this case, the process for creating a table of positions in S8 is omitted from the flow chart of FIG. 12. Moreover, the server 1 carries out a position display process by which each terminal 5 is marked on a seating chart by using the table of terminal information 16, and each terminal 5 carries out a position display process (terminal) by which the terminal 5 is marked on a seating chart by using the table of terminal information 28.

However, since use of the table of positions 17 or 29 makes it possible to smoothly carry out the position display process and the position display process (terminal), it is preferable that each terminal 5 be marked on a seating chart by using the table of positions 17 or 29.

Further, since a seating chart that is displayed needs only show who is sitting in which seat, the seats may be displayed with the names alone without being marked.

Furthermore, the foregoing embodiment has been described by taking, as an example, a case where a seating chart showing an arrangement of seats in one conference room is displayed. However, in the case of a remote conference with another base with the server 1 in connection with a network, a seating chart of that base may be displayed.

Further, the foregoing embodiment has been described by taking, as an example, a case where an angle of rotation at which a lighted LED 21 has been detected is determined, and a position corresponding to that angle in the seat position information 18 which is closest to the angle of rotation is determined as a position in which a terminal 5 including the LED 21 has been placed. However, the method for determining the position of a terminal 5 is not limited to this example.

For example, it is possible to rotate the imaging device 3 by an angle indicated in the seat position information 18, confirm whether or not a lighted LED 21 has been detected, and, if detection of a lighted LED 21 has been confirmed, judge that a terminal 5 including the LED 21 has been placed in a position corresponding to the angle in the seat position information 18.

Further, the foregoing embodiment has been described by taking, as an example, a case where the memory section 15 has only one piece of seat position information 18 stored therein. However, the memory section 15 has plural pieces of seat position information 18 stored therein. For example, it is possible to prestore pieces of seat position information 18 respectively corresponding to seat arrangements such as a two-row arrangement, a U-shaped arrangement, and a circular arrangement and determine seat positions by using seat position information 18 selected from among those pieces of seat position information 18. This makes it possible to handle various seat arrangements.

Because an angle corresponding to each seat position takes out various values according to the size of a conference room and the like, it is preferable that the seat position information 18 be user-registrable. For example, it is possible to place a terminal 5 in each seat position in a conference room where the electronic conferencing system 100 is used, turn on an LED 21, detect the LED 21 by using the imaging device 3, and register, as seat position information 18, each seat position and an angle of rotation at which an LED 21 turned on in each seat position has been detected. Further, it is possible to prestore pieces of seat position information 18 respectively corresponding to general seat arrangements such as a two-row arrangement, a U-shaped arrangement, and a circular arrangement and render parameters such as values of angles in these pieces of seat position information 18 modifiable according to the size, shape, number of seats, etc. of a conference room. This makes it possible to use the electronic conferencing system 100 in various conference rooms.

### Invention of Embodiment 1

An invention of Embodiment 1 can be expressed as follows: An information processing device of Embodiment 1 is an information processing device that is in communications connection with a terminal device including a light-emitting section, including: direction determining means which uses a detection device to detect the light-emitting section emitting light at the terminal device and which determines in which direction the light-emitting section is located with respect to the detection device; a memory section in which to store position-to-direction correspondence information indicating, for a plurality of candidate positions in which the terminal is placed, in which direction each candidate position is located with respect to the detection device; identifying information receiving means which receives via the communications connection from the terminal device user identifying information identifying a user who uses the terminal device; position determining means which determines, by using the position-to-direction correspondence information stored in the memory section and the direction determined by the direction determining means, in which of the plurality of candidate positions the terminal device of the user identified by the user identifying information received by the identifying information receiving means has been placed.

Further, a method of Embodiment 1 for controlling an information processing device is a method for controlling an information processing device that is in communications connection with a terminal device including a light-emitting section, including the steps of: (a) using a detection device to detect the light-emitting section emitting light at the terminal device and determining in which direction the light-emitting section is located with respect to the detection device; (b) receiving via the communications connection from the terminal device user identifying information identifying a user who uses the terminal device; and (c) determining, by using position-to-direction correspondence information indicating, for a plurality of candidate positions in which the terminal is placed, in which direction each candidate position is located with respect to the detection device and the direction determined in step (a), in which of the plurality of candidate positions the terminal device of the user identified by the user identifying information received in step (b) has been placed.

According to the foregoing configuration, a light-emitting section emitting light is detected by the detecting device, and in which direction the light-emitting section is located with respect to the detection device is determined. It should be noted that in a case where a light-emitting section is detected by a detection device having a defined detection range, the direction in which a light-emitting section is located can be determined by an angle of rotation at which the light-emitting section has been brought into the detection region by rotating the detection range on a predetermined axis of rotation.

Further, according to the foregoing configuration, the memory section has the position-to-direction correspondence information stored therein. Since the position-to-direction correspondence information indicates in which direction each candidate position is located with respect to the detection device, the candidate positions can be determined from the direction with respect to the detection device by using the information.

Therefore, the foregoing configuration makes it possible to determine, by using the position-to-direction correspondence information and a direction determined by the direction determining means (in step (a)), in which of the plurality of candidate positions a terminal device having its light-emitting section emitting light has been placed. Further, the foregoing configuration receives the user identifying information of a terminal device having its light-emitting section emitting light, thus making it possible to identify the user of the terminal device.

That is, the foregoing configuration makes it possible to automatically determine which user's terminal device has been placed in which of the plurality of candidate positions. Further, since the candidate position in which the terminal device has been placed is considered to be a seat occupied by the user who uses the terminal device, it also becomes possible to determine which user is seated where.

It should be noted that the candidate position refers to the position of a seat or the like at which a terminal device is placed. Therefore, even in a case where a terminal device has been placed in the same candidate position, the direction determined by the direction determining means (in step (a)) does not always remain the same.

For this reason, the position determining means (step (c)) does not need to always determine, in the position-to-direction correspondence information, a direction that completely coincides with the direction determined by the direction determining means (in step (a)). In a case where the position-to-direction correspondence information does not contain a direction that completely coincides with the direction determined by the direction determining means (in step (a)), it is only necessary to determine a candidate position that corresponds to the closest direction to the direction determined by the direction determining means (in step (a)).

Further, the information processing device is preferably configured to further include terminal control means which, by transmitting a command via the communications connection to a terminal device from which the identifying information receiving means has received user identifying information, causes the light-emitting section of the terminal device to emit light.

According to the foregoing configuration, upon a command from the information processing device, a terminal device having sent user identifying information is made to cause its light-emitting section to emit light. For this reason, even in a case where the information processing device is in communications connection with a plurality of terminal devices, the seat position of a user of that one of the plurality of terminal devices which has sent user identification information can be determined.

Further, the information processing device is preferably configured to further include display processing means which displays an image showing the plurality of candidate positions and which displays, in a candidate position on the image as determined by the position determining means, the user identifying information corresponding to the candidate position or a user name of a user identified by the user identifying information.

The foregoing configuration allows a person who looks at the image to easily recognize what positional relationship the plurality of candidate positions have with each other and in which candidate position a terminal device that is used by the user has been placed.

It should be noted that in a case where the information processing device is in communications connection with a plurality of terminal devices, a candidate position is determined for each terminal device in which the terminal device has been placed, and the user name or user identifying information of the terminal device is displayed in the candidate position.

Moreover, a display device on which the display processing means displays an image may be configured integrally with or separately from the information processing device. In a case where the display device is configured separately, the display device and the information processing device are connected by cable or wireless so that the display device is made to carry out a display.

Further, the information processing device is preferably configured to further include image sending means which sends via the communications connection to the terminal device an image that is displayed by the display processing means.

The foregoing configuration sends to the terminal device an image that is displayed by the display processing means, thus allowing the terminal device to also display the image. This allows the user of the terminal device to view the image at his/her own terminal device.

Further, the information processing device is preferably configured to further include candidate position sending means which sends via the communications connection to the terminal device a candidate position determined by the position determining means and user identifying information corresponding to the candidate position, with the candidate position and the user identifying information being associated with each other.

The foregoing configuration sends to the terminal device a candidate position determined by the position determining means and user identifying information, thus allowing the terminal device to determine, upon receiving them, which user is in which candidate position. This makes it possible for the terminal device to display, in each candidate position, a user name of a user who installs and uses a terminal device in the candidate position, for example.

Further, a terminal device of Embodiment 1 is a terminal device that is in communications connection with the information processing device, including: the light-emitting section; identifying information sending means which sends via the communications connection to the information processing device user identifying information identifying a user who uses the terminal device; and light emission control means which causes the light-emitting section to emit light.

The foregoing configuration sends the user identifying information to the information processing device and causes the light-emitting section to emit light. This allows the information processing device to determine the user who uses the terminal device and determine, by detecting the light-emitting section emitting light, a candidate position in which the terminal device has been placed.

Therefore, the foregoing configuration allows the information processing device to determine which user's terminal device has been placed in which of the plurality of candidate positions.

Further, a terminal device of Embodiment 1 is a terminal device that is in communications connection with the information processing device, including: a display section which displays an image; the light-emitting section; identifying information sending means which sends via the communications connection to the information processing device user identifying information identifying a user who uses the terminal device; light emission control means which causes the light-emitting section to emit light; and terminal-side display processing means which receives an image sent from the image sending means of the information processing device and displays the image on the display section.

The foregoing configuration allows the information processing device to determine which user's terminal device has been placed in which of the plurality of candidate positions. Further, the display section displays an image sent from the image sending means, i.e., an image showing the plurality of candidate positions and a user name of a user who uses a terminal device placed in each candidate position.

Therefore, the foregoing configuration allows a user of a terminal device to easily recognize who is seated where by looking at the display section of the terminal he/she uses.

Further, a terminal device of Embodiment 1 is a terminal device that is in communications connection with the information processing device, including: a display section which displays an image; the light-emitting section; identifying information sending means which sends via the communications connection to the information processing device user identifying information identifying a user who uses the terminal device; light emission control means which causes the light-emitting section to emit light; and terminal-side display processing means which receives a plurality of candidate positions and user identifying information sent from the candidate position sending means of the information processing device, which displays an image showing the plurality of candidate positions, and which displays, in each candidate position in the image, the user identifying information corresponding to the candidate position or a user name of a user identified by the user identifying information.

The foregoing configuration allows the information processing device to determine which user's terminal device has been placed in which of the plurality of candidate positions. Further, the display section displays an image showing the plurality of candidate positions and a user name or user identifying information of a user who uses a terminal device placed in each candidate position.

Therefore, the foregoing configuration allows a user of a terminal device to easily recognize who is seated where by looking at the display section of the terminal device he/she uses.

The configuration for displaying, on the display section of the terminal device, each candidate position and the user name or user identifying information of a terminal device placed in that candidate position is not limited to that described above, with the candidate position and the user name or user identifying information being associated with each other. For example, the terminal device may be configured to either have the position-to-direction correspondence information stored in advance therein or acquire it from the information processing device and receive from the information processing device the direction determined by the direction determining means and the user identifying information of a terminal device having its light-emitting section detected.

This configuration allows the terminal device to use the position-to-direction correspondence information to determine which user's terminal device has been placed in which candidate position, and also to display each candidate position and the user name of a terminal device placed in that candidate position, with the candidate position and the user name being associated with each other.

Further, the terminal device of Embodiment 1 is preferably configured such that: the image showing the plurality candidate positions is an image of a seating chart on which seats respectively corresponding to the candidate positions have been drawn; and the terminal-side display processing means displays the image of the seating chart in such an orientation that the front of a seat corresponding to a candidate position in which the terminal device has been placed faces upward in the image.

According to the foregoing configuration, the image of the seating chart is displayed in such an orientation that the front of a seat corresponding to a candidate position in which the terminal device has been placed faces upward in the image. With this, the frontward direction in which the user of the terminal is facing and the orientation of seats displayed on the display section of the terminal device can be matched. This allows the user to easily grasp the positional relationship between the seats.

Further, an information processing system including the information processing device and the terminal device that is in communications connection with the information processing device brings about the same effects as those brought about by the information processing device and the terminal device. It should be noted that the information processing system may include a display device which the display processing means causes to display an image.

It should be noted that the information processing device and the terminal device may be realized by computer. In this case, a control program for causing the information processing device and the terminal device to be realized by computer by causing a computer to operate as each means of the information processing device and the terminal device and a computer-readable recording medium containing such a control program are also encompassed in the scope of the present invention.

### Embodiment 2

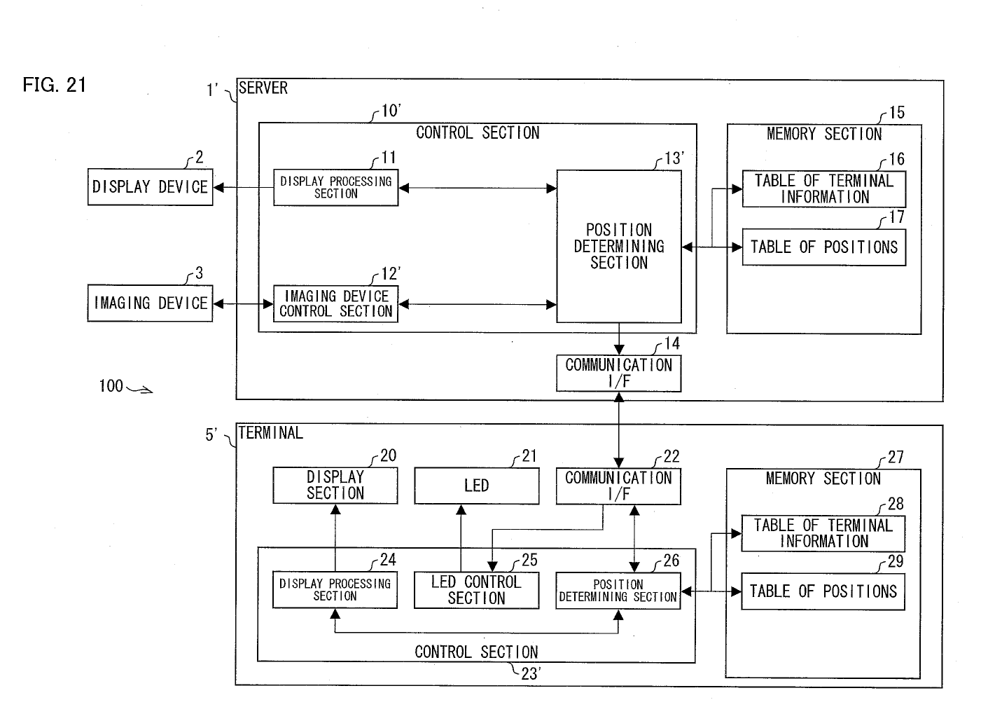

A second embodiment of the present invention is described below with reference to FIGS. 21 through 26. It should be noted that the same components as those of the foregoing embodiment are given the same numbers and are not described below.

[Overview of an Electronic Conferencing System]

As with the electronic conferencing system 100 (see FIGS. 2 and 3), an electronic conferencing system 100′ of the present embodiment is configured to include a server (information processing device) 1′, a display device 2, an imaging device (detection device) 3, and terminals (terminal devices) 5′. Each of the terminals 5′ is provided with an LED (light-emitting diode, light-emitting section) 21.

That is, in the electronic conferencing system 100′, too, the conference is conducted by using the display device 2. Moreover, each participant participates in the conference while looking at the conference materials with his/her terminal 5′, writes as needed on a document displayed on his/her terminal 5′, and causes the display device 2 to display the document via the server 1′. This allows him/her to present the document to the other participants.

Further, the display device 2 displays a seating chart generated by the server 1′ determining the position of each participant in the conference room (see FIG. 4). This allows each participant to easily recognize who is sitting in which seat in the conference room. A main feature of the electronic conferencing system 100′, too, lies in a process for generating and displaying such a seating chart.

[Flow of a Process in the Electronic Conferencing System 100′]

The electronic conferencing system 100′ is identical to the electronic conferencing system 100, except that the seat position of a user of a terminal 5′ having its LED 21 detected lighted is determined in accordance with the direction in which the LED 21 was detected and the distance to the LED 21 detected. For this reason, the flow of a process in the electronic conferencing system 100′ is identical to the flow of a process in the electronic conferencing system 100 (FIGS. 5 and 6).

[Configurations of Main Parts of the Server 1′ and Each Terminal 5′]

Next, configurations of main parts of the server 1′ and each terminal 5′ are described with reference to FIG. 21. FIG. 21 is a block diagram showing configurations of main parts of the server 1′ and each terminal 5′. It should be noted that FIG. 21 omits to illustrate the imaging control device 4.

First, a configuration of a main part of the server 1′ is described. As shown in FIG. 21, the server 1′ includes a control section 10′, a communication I/F 14, and a memory section 15.

The control section 10′ has overall control of the operation of the server 1′, and includes a display processing section (display processing means) 11, an imaging device control section (direction determining means, distance determining means) 12′, and a position determining section (identifying information receiving means, terminal control means, position determining means, image sending means, position information sending means) 13′.

The imaging device control section 12′ acquires a distance from the imaging device 3 to a glowing LED 21 from the imaging device 3 as measured by the imaging device 3 for focusing on the LED 21. The position of a terminal 5′ including the glowing LED 21 is determined by using the distance and an angle of rotation.

The position determining section 13′ carries out a process for determining the seat position of each participant. Specifically, upon receiving login information via the communication I/F 14, the position determining section 13′ commands the terminal 5′ from which the login information was sent to turn on its LED 21, and causes the imaging device control section 12′ to determine the direction of and the distance to the LED 21 thus turned on. Then, the position determining section 13′ determines, from the direction and distance thus determined, the seat position in which the terminal 5′ has been placed, i.e., the seat position of a participant who uses the terminal 5′. The position determining section 13′ determines the seat position of each participant by carrying out such a process for each terminal 5′.

The memory section 15 is a memory device in which to store data necessary for the server 1′ to operate. The memory section 15 has a table of terminal information 16′ and a table of positions 17 stored therein. These tables will be described later.

Next, a configuration of a main part of each terminal 5′ is described. As shown in FIG. 21, each terminal 5′ includes a display section 20, an LED 21, a communication I/F 22, a control section 23′, and a memory section 27. It should be noted each terminal 5′ may include a microphone 22 as shown in FIG. 2.

The control section 23′ has overall control of the operation of the terminal 5′, and includes a display processing section (terminal-side display processing means) 24, an LED control section (light emission control means) 25, and a position determining section (identifying information sending means) 26′.

The memory section 27 is a memory device in which to store data necessary for the terminal 5′ to operate. The memory section 27 has a table of terminal information 28′ and a table of positions 29 stored therein. These tables are tables obtained by receiving the table of terminal information 16′ and the table of positions 17′, which are stored in the memory section 15 of the server 1′, from the server 1′ and storing them in the memory section 27.

[Details of the Table of Terminal Information 16′]

Next, the table of terminal information 16′ is described in detail. The table of terminal information 16′ is a table for managing a terminal 5′ having logged into the electronic conferencing system 100′. When a terminal 5′ has logged in, information on that terminal 5′ is stored in the table.

Specifically, the table of terminal information 16′ contains identification information for identifying a terminal 5′ having logged in, the full name of a participant in the conference who uses the terminal 5, and the like. This makes it possible to determine which terminal 5′ is being used and who is using that terminal 5′. Further, the table of terminal information 16′ also has stored therein information indicating angles and distances acquired by the imaging device control section 12′.

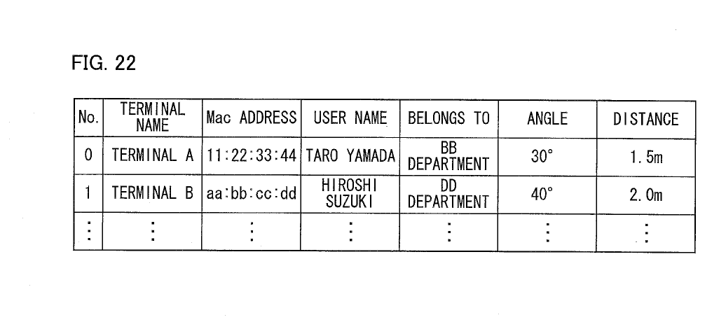

The table of terminal information 16′ can be in such an aspect as that shown in FIG. 22. FIG. 22 is a diagram showing an example of a table of terminal information 16′. The table of terminal information 16′ of FIG. 22 contains seven items of information, namely “NO.”, “TERMINAL NAME”, “Mac ADDRESS (media access control address)”, “USER NAME”, “BELONGS TO”, “ANGLE”, and “DISTANCE”.

The item “DISTANCE” refers to distances from the imaging device 3 to the LEDs 21. How to find such a distance is described below in detail. It should be noted that the items other than the item “DISTANCE” are identical to those described in the foregoing embodiment.

[How to Find a Distance]

A method for determining a distance that is stored in the table of terminal information 16′, i.e., the distance from the imaging device 3 to an LED 21 detected lighted is described with reference to FIG. 11.

It is assumed here that the imaging device 3 has an autofocusing function of measuring the distance to an object to be imaged and taking the focus in accordance the distance thus measured. For this reason, a distance measured by the imaging device 3 for focusing on a lighted LED 21 is determined as a distance from the reference point to the LED 21.

Further, in the case of a circular arrangement, as in the case of (a) of FIG. 11, the distances from the imaging device 3 to the LEDs 21 can be determined. In the case of a circular arrangement, however, the distances are all equal or substantially equal. For this reason, in a case where it is known beforehand that the terminals 5′ are arranged in a circle, the distance that was first determined may be applied directly to the other LEDs 21, so that the number of times the distances are determined can be reduced.

The distance measured by the imaging device 3 and the distance from the reference point to the LED 21 do not technically match each other. However, the distance determined here needs only have such a degree of accuracy that the position of each terminal 5′ in a conference room can be roughly determined. Therefore, the method of determining is sufficient.

[Details of the Table of Positions 17]

Next, the table of positions 17 is described in detail. The table of positions 17 is a table in which the terminals 5′ contained in the table of terminal information 16′ are arranged in the order of angles. In a case where an arrangement of seats is known beforehand, the server 1′ uses a seating chart template, which will be described later, to display a seating chart showing the name of each participant. Use of the table of positions 17 in displaying a seating chart by using a seating chart template makes an efficient display as that shown in FIG. 8.

[Seating Chart Template]

The server 1′ can determine the position of each terminal 5′ by using an angle of rotation and a distance, and can display, as a seating chart, the positions thus determined. In a case where an arrangement of seats (candidate positions as candidates in which the terminals 5′ are placed) is known beforehand, the server 1′ uses the arrangement of seats as a template, thereby making it possible to more accurately determine the seat position of each participant.

The seating chart template is described here with reference to the example arrangements of seats of FIG. 9. That is, data indicative of such an arrangement of seats as those shown in FIG. 9 can be used as a seating chart template.

In the seating chart template shown in (a) of FIG. 9, the seats (1) to (4) are arranged in a direction perpendicular to the display surface of the display device 2 on the right as one faces the display surface, and the seats (5) to (8) are arranged in a direction perpendicular to the display surface of the display device 2 on the left as one faces the display surface.

It should be noted that the positional relationship between the reference point, the reference line, and each seat in the seating chart template corresponds to the actual positional relationship between the reference point (position of the axis of rotation of the imaging device 3), the reference line, and each seat. In other words, the seating chart template is a miniature version of the actual arrangement. This makes it possible to determine, from the angle of rotation determined by detecting an LED 21, at which seat in the seating chart template a terminal 5′ including the LED 21 has been placed.

It should be noted that the front of the seats (1) to (4) faces downward in (a) of FIG. 9, and the front of the seats (5) to (8) faces upward in (a) of FIG. 9. That is, those participants sitting in the seats (1) to (4) and those participants sitting in the seats (5) to (8) face each other. Since the seating chart template specifies which seat is facing in which direction, use of the seating chart template makes it possible to determine the direction in which a participant is facing, while the direction in which a participant is facing cannot be determined by using an angle of rotation and a distance only.

Further, in the case of a seating chart template for a U-shaped arrangement shown in (b) of FIG. 9, too, the position of each participant can be more accurately determined, and the direction in which each participant is facing can be determined, as in the case of the seating chart template of (a) of FIG. 9. In the illustrated example, those participants sitting in the seats (1) to (4) and those participants sitting in the seats (7) to (10) face each other, and those participants sitting in the seats (5) and (6) faces the display surface of the display device 2.

In the case of a seating chart template of a circular arrangement shown in (c) of FIG. 9, too, the same applies as in the cases of (a) and (b) of FIG. 9. In the illustrated example, the front of each of those participants sitting in the seats (1) to (8) faces the imaging device 3.

[Flow of a Process that is Executed by the Server 1′]

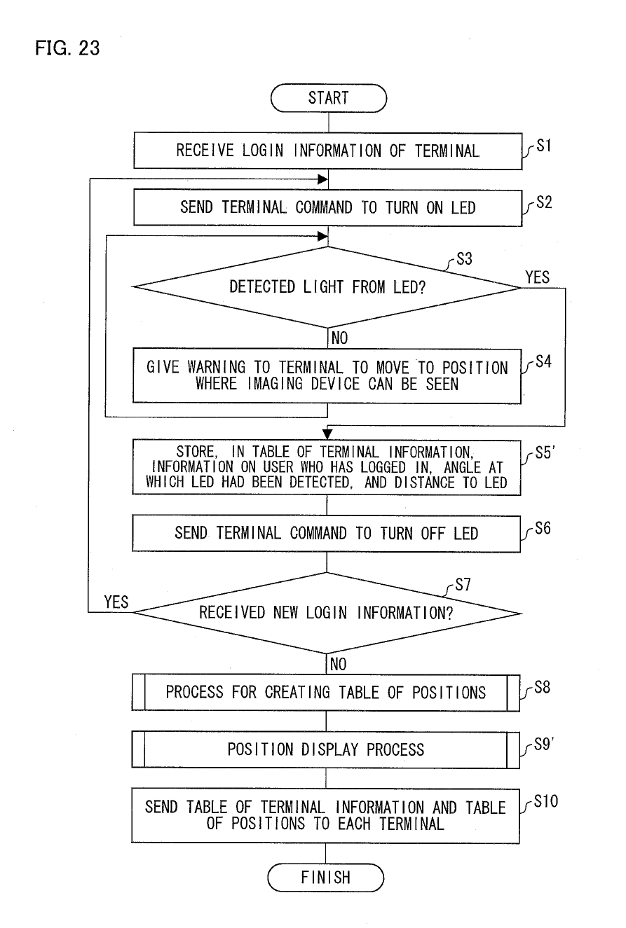

The flow of a process that is executed by the server 1′ is described with reference to FIG. 23. FIG. 23 is a flow chart showing an example of a process that is executed by the server 1′. It should be noted that the flow chart of FIG. 23 is identical to the process of FIG. 12 except for the steps S5′ and S9′. The step S5′ is described here, and the step S9′ will be described later.

If detection of the LED 21 thus turned on has been confirmed in S3 (YES in S3), the position determining section 13′ acquires, from the imaging device control section 12′, an angle at which the LED 21 thus turned on has been detected and a distance to the LED 21. As explained with reference to FIG. 11, the angle is an angle by which the imaging device 3 has rotated from the reference line.

Further, the position determining section 13′ determines, from the login information received in S1, the participant who has logged into the terminal 5′, and acquires information on the participant (his/her full name and the department to which he/she belongs). Then, the position determining section 13′ stores, in the table of terminal information 16′, the acquired angle, the acquired distance, and the acquired information on the participant (S5′).

(Flow of the Process for Creating a Table of Positions)

The process for creating a table of positions as carried out in S8 of FIG. 23 is identical to the process shown in FIG. 13, and as such, is not described here.

[Flow of the Position Display Process]

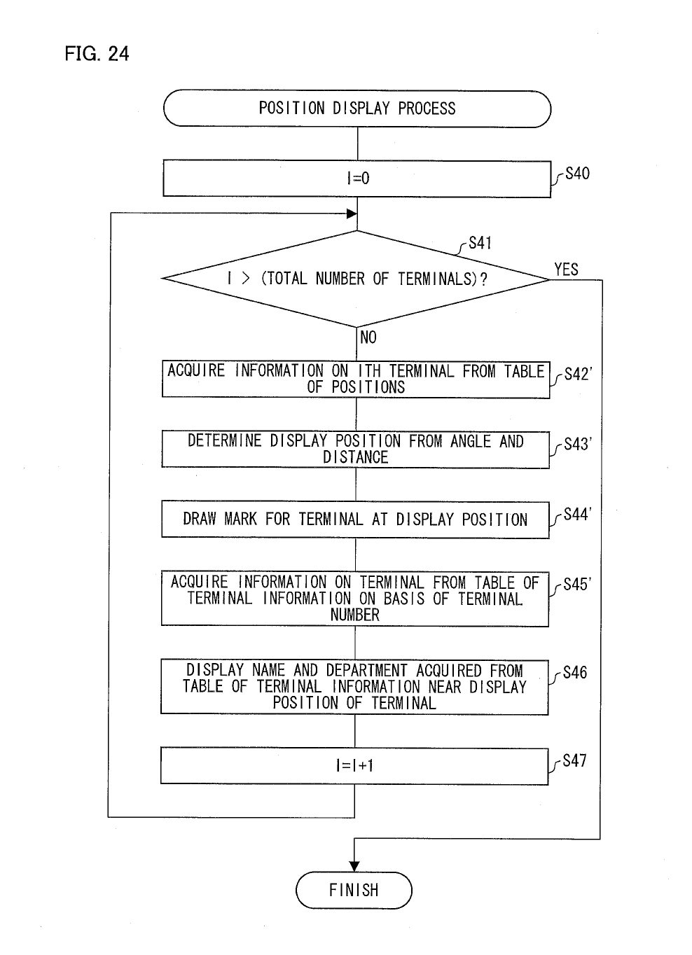

Next, the position display process that is carried out in S9′ of FIG. 23 is described in detail with reference to FIG. 24. FIG. 24 is a flow chart showing an example of a position display process. It should be noted that since the position display process of FIG. 24 is identical to the position display process of FIG. 14 except for the steps S42′ to S45′, the steps S42′ to S45′ are described here.

If the position determining section 13′ has judged NO in S40, the position determining section 13′ acquires information on the Ith terminal 5′ from the table of positions 17 (S42′). It should be noted that the information on the terminal 5′ acquired here is a terminal name and a distance.

Since the position of the Ith terminal 5′ is determined by the angle and distance acquired in S42′, the position determining section 13′ instructs the display processing section 11 to draw a mark for the terminal in the position determined by the angle and distance.

In the case of use of a seating chart template (see FIG. 9), the display processing section 11 causes the display device 2 to display the seating chart template. Then, the display processing section 11 draws a mark for the terminal 5′ at the closest seat to the position determined by the angle and distance.

It should be noted that in the case of use of a seating chart template, correspondence information of correspondence between the position of each seat and the angle and distance may be created in advance. This makes it possible to easily determine the position of each seat from the angle and the distance by using the correspondence information.

On the other hand, in a case where a seating chart template is not used, the display processing section 11 draws an image of a blank seating chart, and sets a reference point in the image. Then, the display processing section 11 draws a mark for the terminal 5′ in the position determined by the angle and distance from the reference point thus set. At this point in time, the display processing section 11 may draw an image showing the positions of the display device 2 and the imaging device 3, together with the mark for the terminal 5′. This allows a participant who looks at this image to easily recognize the positional relationship between the seats on the seating chart. It should be noted the mark to be drawn here needs only be such that the presence of a participant sitting in the seat can be recognized.

After that, the display processing section 11 acquires information on the terminal 5′ for which a mark has been drawn from the table of terminal information 16′ (S45′).

[Examples of Images that are Displayed on the Display Device 2]

As in Embodiment 1, a seating chart that is displayed on the display device 2 by the aforementioned position display process looks like those shown in FIG. 15, for example.

As shown in (a) of FIG. 15, by displaying a seating chart showing who is sitting in which seat, the display device 2 allows each participant in a conference to recognize at one glance who is in the conference and where he/she is seated. Further, a speaker's seat is marked in such a manner as to be distinguishable from the other seat. In a case where a seating chart template is used, an unoccupied seat is displayed as such. On the other hand, in a case where a seating chart template is not used, only those seats having their terminals 5′ logged into are displayed.

[Flow of the Position Display Process (Terminal)]

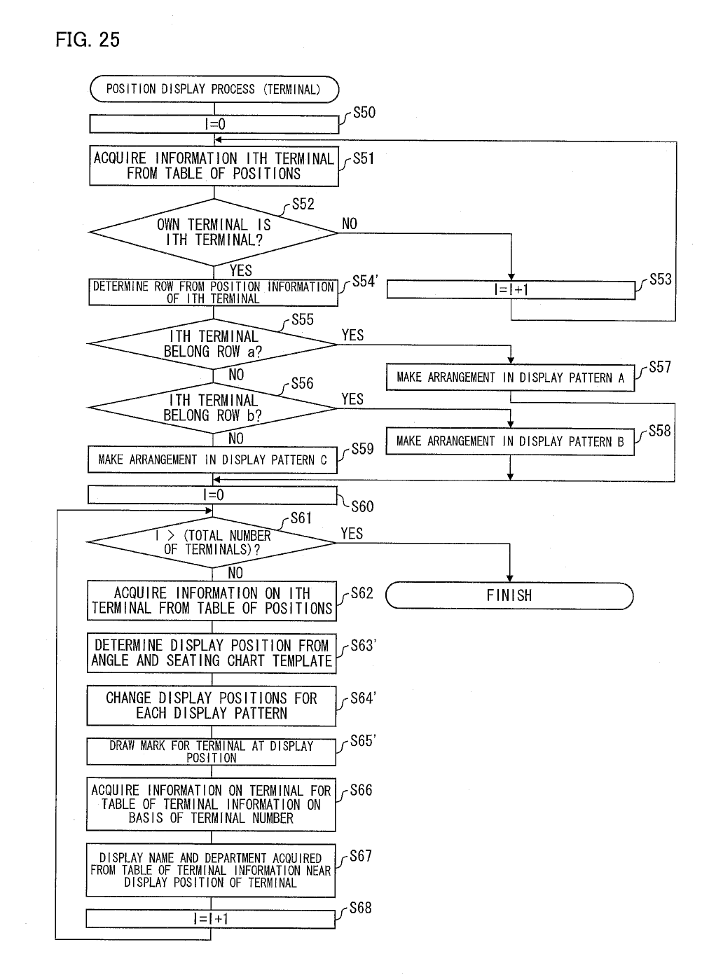

The flow of the position display process (terminal) is described with reference to FIG. 25. FIG. 25 is a flow chart showing an example of a position display process (terminal). It should be noted that the position display process (terminal) is a process that is carried out by a terminal 5′ having received the table of terminal information 16′ and the table of positions 17 sent from the server 1′ in S10 of FIG. 23. Since the position display process (terminal) of FIG. 25 is identical to the position display process (terminal) of FIG. 16 except for the steps S54′ and S63′ to S65′, the steps S54′ and S63′ to S65′ are mainly described here.

Then, when the position determining section 26′ has confirmed that its corresponding terminal is the Ith terminal (YES in S52), the position determining section 26′ reads out the angle of the Ith terminal 5′ from the table of positions 29. Then, by using the angle thus read out and a seating chart template, the position determining section 26′ determines which of the rows a to c its corresponding terminal belongs to (S54′).

That is, the example shown in FIG. 25 is premised on the use of a seating chart template. For this reason, let it be assumed that the seating chart template and the correspondence between the seat positions and the rows a to c are stored in advance.

Then, the position determining section 26′ confirms whether the Ith terminal 5′, i.e., its corresponding terminal belongs either or neither of the rows a and b (S55, S56). If the position determining section 26′ has confirmed here that the Ith terminal 5′ belongs to the row a (YES in S55), the position determining section 26′ decides to make an arrangement in a display pattern A (S57), and proceeds to the step S60. On the other hand, if the position determining section 26′ has confirmed here that the Ith terminal 5′ belongs to the row b (NO in S55, YES in S56), the position determining section 26′ decides to make an arrangement in a display pattern B (S58), and proceeds to the step S60. Alternatively, the position determining section 26′ has confirmed here that the Ith terminal 5′ belongs to neither the row a nor b (NO in S55, NO in S56), the position determining section 26′ decides to make an arrangement in a display pattern C (S59), and proceeds to the step S60.

It should be noted that the steps S51 to S59 may be carried out by using the table of terminal information 28′ (as obtained by receiving the table of terminal information 16′ from the server 1′ and storing it in the memory section 27). In this case, the position determining section 26′ acquires the Ith information from the table of terminal information 28′ in S51, and determines, by using the angle read out from the table of terminal information 28′ and the seating chart template, to which row its corresponding terminal belongs.

In S60, the position determining section 26′ configures the settings so that I=0, and then confirms whether or not I exceeds the total number of terminals (S61). It should be noted that the total number of terminals is the total number of terminals whose information has been stored in the table of positions 29.

Since the settings have been configured in S60 so that I=0, the position determining section 26′ judges that the value of I is equal to or less than the total number of terminals (NO in S61), and acquires information on the Ith terminal from the table of positions 29 (S62). It should be noted that the information on the terminal that is acquired here is a terminal name and an angle. Next, the position determining section 26′ determines the position of the Ith terminal by using the angle acquired in S62 and the seating chart template (S63′).

The position determining section 26′ changes, in accordance with the display pattern determined in the steps S55 to S59, the display positions determined in S63 (S64′). Specifically, in the case of the display pattern A, the position determining section 26′ determines the orientation of the seating chart template so that the row b, the display device 2, and the row a are displayed on the upper side, the right side, and the lower side, respectively. Similarly, in the case of the display pattern B, the position determining section 26′ determines the orientation of the seating chart template so that the row a, the display device 2, and the row b are displayed on the upper side, the left side, and the lower side, respectively. In the case of the display pattern C, the position determining section 26′ determines the orientation of the seating chart template so that the row a, the display device 2, the row b, and the row c are displayed on the right side, the upper side, the left side, and the lower side, respectively.

Then, the position determining section 26′ instructs the display processing section 24 to display the terminal on the seating chart template oriented as determined in S64′. Upon receiving the instruction, the display processing section 24 draws the seating chart template in the orientation determined in S64′ and further draws a mark for the terminal 5′ in that position on the seating chart which has been determined in S63 (S65′), and causes the display section 20 to display the image thus drawn.

In the foregoing example, the display position is determined in S63 by using the angle and the seating chart template. However, this example does not imply any limitation. For example, the display position may be determined by using the angle, the distance, and the seating chart template. In this case, a plurality of seats existing at the same angle can be displayed in distinction from each other.

Further, for example, in the case of use of a seating chart template in the server 1′, too, position information indicating seat positions on the seating chart template may be sent from the server 1′ to each terminal 5′ so that the terminal 5′ can determine a display position by using the position information. Usable examples of the position information include numbers and symbols given in advance to the respective seats on the seating chart template.

Furthermore, the display position may be determined by using the angle and distance read out from the table of terminal information 28′ received from the server 1′, without using a seating chart template. In this case, however, the orientation of a seat is not determined. Therefore, the steps S50 to S59 and S64′ of the flow chart of FIG. 25 are not carried out.

Further, the present embodiment has shown a case where by sending the table of terminal information 16′ and the table of positions 17 from the server 1 to a terminal 5′ and carrying out the position display process (terminal) at the terminal 5′ having received the table of terminal information 16′ and the table of positions 17, the display section 20 is made to display a seating chart.

However, a configuration for causing the display section 20 of a terminal 5′ to display a seating chart is not limited to this example. For example, an image that is displayed on the display device 2 by the position display process that is carried out by the server 1′ may be sent to the terminal 5′, for example, by the position determining section 13′ of the server 1′ so that the display section 20 displays the image. In this case, the display processing section 24′ of the terminal 5′ needs only cause the image thus received to be displayed, and the position determining section 26′ no longer needs to carry out the position display process (terminal).

[Examples of Images that are Displayed on the Display Section 20]

As in Embodiment 1, a seating chart that is displayed on the display section 20 by the aforementioned position display process (terminal) looks like those shown in FIG. 18, for example.

[Flow of the Position Display Process (Terminal) in the Case of a Circular Arrangement of Seats]

The position display process (terminal) in the case of a two-row arrangement of seats or a U-shaped arrangement of seats has been described with reference to FIG. 25. In the case of a circular arrangement of seats, however, there is no more distinction between the row a, the row b, the row c, etc. This means a slight change in content of the position display process (terminal).

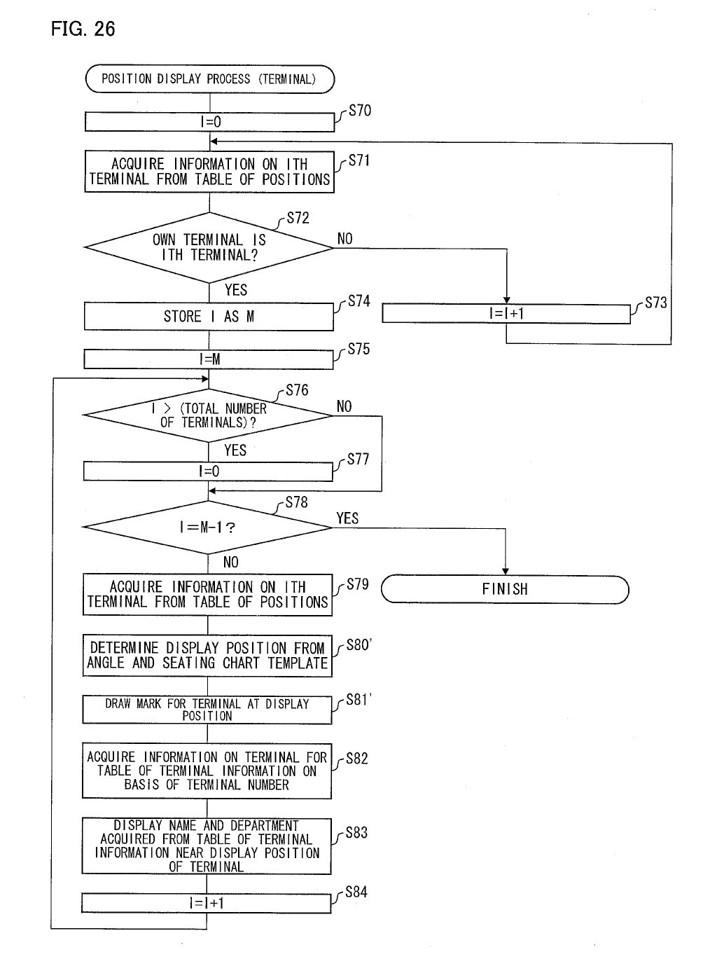

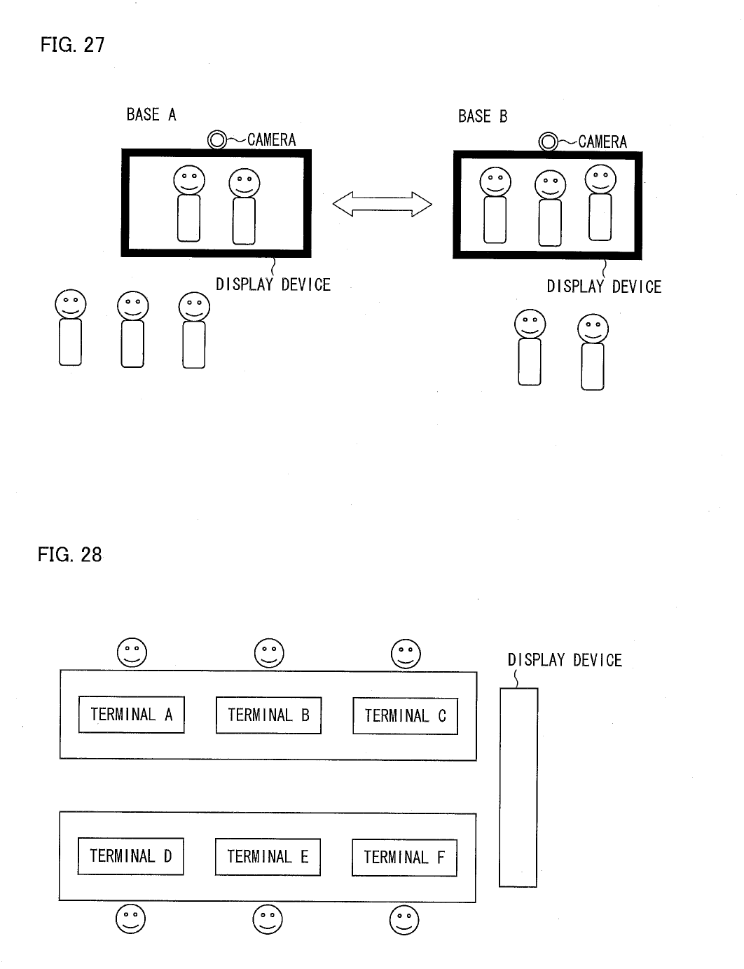

The flow of the position display process (terminal) in the case of a circular arrangement of seats is described here with reference to FIG. 26. FIG. 26 is a flow chart showing an example of a position display process (terminal) in the case of a circular arrangement of seats. It should be noted that the settings have been configured in advance for each terminal 5′ as to whether or not the seats are arranged in a circle, the position display process (terminal) as shown in FIG. 25 or FIG. 26 is carried out on the basis of the settings. Since the position display process (terminal) of FIG. 26 is identical to the position display process (terminal) of FIG. 19 except for the steps S80′ and S81′, the steps S80′ and S81′ are described here.

In S80′, the position determining section 26′ determines the position of the Ith terminal by using the angle acquired in S79 and a seating chart template, and then sends the display processing section 24 an instruction to display a seating chart.

Upon receiving the display instruction, the display processing section 24 draws a seating chart template of a circular arrangement in such an orientation that the seat position of its corresponding terminal is on the lowermost side of the screen and further draws a mark for the terminal 5′ in the seat position on the seating chart template which has been determined in S80′ (S81′), and causes the display section 20 to display the image thus drawn.

[Example of an Image that is Displayed on the Display Section 20]

As in Embodiment 1, a seating chart that is displayed on the display section 20 by the aforementioned position display process (terminal) looks like that shown in FIG. 20, for example.

[Modification]

The foregoing embodiment has been described by taking, as an example, a case where each terminal 5′ is marked on a seating chart by using the table of positions 17 or 29. However, such marking can be done without using the table of positions 17 or 29. In this case, the process for creating a table of positions in S8 is omitted from the flow chart of FIG. 23. Moreover, the server 1′ carries out a position display process by which each terminal 5′ is marked on a seating chart by using the table of terminal information 16′, and each terminal 5′ carries out a position display process (terminal) by which the terminal 5′ is marked on a seating chart by using the table of terminal information 28′.

In a case where a seating chart template is used, however, use of the table of positions 17 or 29 makes it possible to smoothly carry out the position display process and the position display process (terminal), it is preferable that each terminal 5′ be marked on a seating chart by using the table of positions 17 or 29.

Further, since a seating chart that is displayed needs only show who is sitting in which seat, the seats may be displayed with the names alone without being marked.

Further, the foregoing embodiment has been described by taking, as an example, a case where a seating chart showing an arrangement of seats in one conference room is displayed. However, in the case of a remote conference with another base with the server 1′ in connection with a network, a seating chart of that base may be displayed.

Further, the foregoing embodiment has been described by taking, as an example, a case where the direction in which a terminal 5′ exists is determined by an angle of horizontal rotation of the imaging device 3. However, this example does not imply any limitation. For example, by configuring the imaging device 3 so that its imaging region can move horizontally and vertically with the imaging device 3 as the center and acquiring angles of horizontal and vertical rotation angles of horizontal and vertical rotation, the seat position may be determined from these angles of rotation. In this case, by placing the imaging device 3 in such a position that it can look down on each seat, the seat position can be determined solely from angles of horizontal and vertical rotation without using a distance or a seating chart template.

Furthermore, the direction in which a terminal 5′ exists can be determined without using an angle of rotation. For example, the direction in which a terminal 5′ exists may be determined by taking an image including each seat and in accordance with the position of a lighted LED 21 in the image thus taken.

Further, the foregoing embodiment has been described by taking, as an example, a case where the position of a terminal 5′ is determined by using a distance measured by the imaging device 3 for focusing on an LED 21. However, distance may be measured by using a different device from the imaging device 3. Examples of the device that is used to measure distance include an infrared range sensor, an ultrasonic distance sensor, etc.

The present invention is not limited to the description of the embodiments above, but may be altered by a skilled person within the scope of the claims. An embodiment based on a proper combination of technical means disclosed in different embodiments is encompassed in the technical scope of the present invention.

Finally, the blocks of the servers 1 and 1′ and the terminals 5 and 5′ or, in particular, the control sections 10 and 10′ and the control sections 23 and 23′ may be achieved through hardware logic or through software by using a CPU as described below.

That is, the servers 1 and 1′ and the terminals 5 and 5′ each include: a CPU (central processing unit), which executes instructions from a program for achieving the corresponding function; a ROM (read only memory), in which the program is stored; an RAM (random access memory), to which the program is loaded; a memory device (recording medium), such are stored; and the like. Moreover, the object of the present invention can be attained by mounting, to the servers 1 and 1′ and the terminals 5 and 5′, a recording medium computer-readably containing a program code (an execute form program, intermediate code program, or source program) of a program for controlling the servers 1 and 1′ and the terminals 5 and 5′, which is software for achieving the aforementioned function, in order for the CPU to retrieve and execute the program code recorded in the recording medium.

Examples of the recording medium encompass: tapes, such as magnetic tapes and cassette tapes; disks including magnetic disks, such as floppy disks (registered trademark) and hard disks, and optical disks, such as CD-ROMs, MOs, MDs, BDs, DVDs, and CD-Rs; cards, such as IC cards (including memory cards) and optical cards; and semiconductor memories, such as mask ROMs, EPROMs, EEPROMs, and flash ROMs.

Further, the servers 1 and 1′ and the terminals 5 and 5′ can be made connectable to a communication network, so that the program code can be supplied via the communication network. Examples of the communication network include, but are not particularly limited to, the Internet, an intranet, an extranet, a LAN, ISDN, a VAN, a CATV communication network, a virtual private network, a telephone line network, a mobile communication network, a satellite communication network, etc. Further, a transmission medium constituting the communication network is not particularly limited. For example, it is possible to use, as the transmission medium, a cable system such as IEEE 1394, a USB, a power line, a cable TV line, a telephone line, an ADSL line, etc. Alternatively, it is possible to use, as the transmission medium, a wireless system such as infrared rays as in IrDA and a remote controller, Bluetooth (registered trademark), 802.11 wireless, HDR, a cellular-phone network, a satellite line, a terrestrial digital network, etc. It should be noted that the present invention can be achieved in the form of a computer data signal realized by electronic transmission of the program code and embedded in a carrier wave.

### Invention of Embodiment 2

An invention of Embodiment 2 can be expressed as follows: An information processing device of Embodiment 2 is an information processing device that is in communications connection with a terminal device including a light-emitting section, including: direction determining means which uses a detection device to detect the light-emitting section emitting light at the terminal device and which determines in which direction the light-emitting section is located with respect to the detection device; distance determining means which determines the distance from the detection device to the light-emitting section; identifying information receiving means which receives via the communications connection from the terminal device user identifying information identifying a user who uses the terminal device; and position determining means which determines, as the seat position of the user identified by the user identifying information received by the identifying information receiving means, a position away from the detection device by the distance determined by the distance determining means in the direction determined by the direction determining means.

Further, a method of Embodiment 2 for controlling an information processing device is a method for controlling an information processing device that is in communications connection with a terminal device including a light-emitting section, including the steps of: (a) using a detection device to detect the light-emitting section emitting light at the terminal device; (b) determining in which direction the light-emitting section is located with respect to the detection device; (c) determining the distance from the detection device to the light-emitting section; (d) receiving via the communications connection from the terminal device user identifying information identifying a user who uses the terminal device; and (e) determining, as the seat position of the user identified by the user identifying information received in the step (d), a position away from the detection device by the distance determined in the step (c) in the direction determined in the step (b).

According to the foregoing configuration, the terminal device is provided with the light-emitting section; therefore, the position of the terminal device can be determined by determining of the position of the light-emitting section emitting light. Further, since the terminal device is placed at a seat occupied by a user who uses the terminal device, the position of the terminal device can be considered as the seat position of the user.

Accordingly, the foregoing configuration determines detect the light-emitting section emitting light and determines in which direction the light-emitting section is located with respect to the detection device, and also determines the distance from the detection device to the light-emitting section. Further, the foregoing configuration receives from the terminal device user identifying information identifying a user who uses the terminal device.

Then, the foregoing configuration determines, as the seat position of the user identified by the user identifying information received, a position away from the detection device by the distance thus determined in the direction thus determined, thus making it possible to automatically determine the seat position of the user.

Further, the information processing device is preferably configured to further include terminal control means which, by transmitting a command via the communications connection to a terminal device from which the identifying information receiving means has received user identifying information, causes the light-emitting section of the terminal device to emit light.

According to the foregoing configuration, upon a command from the information processing device, a terminal device having sent user identifying information is made to cause its light-emitting section to emit light. For this reason, even in a case where the information processing device is in communications connection with a plurality of terminal devices, the seat position of a user of that one of the plurality of terminal devices which has sent user identification information can be determined.

Further, the information processing device is preferably configured such that: the detection device is a device which takes an image; and the direction determining means detects the light-emitting section by causing an imaging region of the detection device to rotate on the detection device and determines, as the direction in which the light-emitting section is located, an angle of rotation of the imaging region at which the light-emitting section has been detected.

As mentioned in the [Background Art] section, it is usual in an electronic conferencing system to take an image of a participant in a conference with an imaging device such as a camera, send the image thus taken to another base, and/or display the image on a large-sized display device.

That is, the foregoing configuration makes it possible to determine the direction of a light-emitting section by using an imaging device included in a general electronic conferencing system as a detection device for determining the seat direction of a user.

It should be noted that rotation of the imaging region may be carried out by rotating the detection device at a certain reference point or on a certain axis of rotation, or only the imaging region may be moved without moving the detection device. Further, an angle of rotation can be determined by presetting a reference segment starting at the reference point or axis of rotation.

Further, the information processing device is preferably configured such that: the detection device has a function of measuring the distance from the detection device to an object to be imaged and focusing on the object to be imaged by using the distance thus measured; and the distance determining means determines, as the distance from the detection device to the light-emitting section, the distance measured by the detection device for focusing on the light-emitting section.

The foregoing configuration is on the premise that the detection device has a function of measuring the distance from the detection device to an object to be imaged and focusing on the object to be imaged by using the distance thus measured, i.e., an autofocusing function. Then, the foregoing configuration acquires the distance measured by the detection device by using the function, and determines the distance as the distance from the detection device to the light-emitting section.

That is, according to the foregoing configuration, the direction of a light-emitting section and the distance to the light-emitting section can be determined by an imaging device included in a general electronic conferencing system; therefore, the cost of building an electronic conferencing system using the information processing device can be reduced.

Further, the information processing device is preferably configured to be in communications connection with a plurality of terminal devices each including a light-emitting section, further including: display processing means which displays each seat position determined by the position determining means separately for the plurality of terminal devices and either the user identifying information corresponding to the seat position or a user name of a user identified by the user identifying information, with the seat position and either the user identifying information or the user name being associated with each other.

The foregoing configuration displays the seat position of each user and either the user identifying information corresponding to the seat position or a user name of a user identified by the user identifying information, with the seat position and the user identifying information or user name being associated with each other. This allows a person who looks at the display to easily recognize what positional relationship one seat has with another and who is using which seat.

For displaying a user name, it is only necessary to create in advance a database of correspondence between user identifying information and a user name of a user identified by the user identifying information and identify a user name corresponding to the user identifying information with reference to the database.

Moreover, a display device on which the display processing means displays an image may be configured integrally with or separately from the information processing device. In a case where the display device is configured separately, the display device and the information processing device are connected by cable or wireless so that the display device is made to carry out a display.

Further, the information processing device is preferably configured such that: the terminal device is placed in any one of a plurality of predetermined candidate positions, the information processing device further including display processing means which displays an image showing an arrangement of the plurality of candidate positions and which displays, in that one of the plurality of candidate positions shown in the image which corresponds to the position determined by the position determining means, the user identifying information or a user name of a user identified by the user identifying information.

In a case where a candidate position in which the terminal device is placed is known beforehand, the seat position of each user and either the user identifying information corresponding to the seat position or a user name of a user identified by the user identifying information can be displayed as described above. This makes it possible to easily recognize who is using which seat.

Further, the information processing device is preferably configured to further include image sending means which sends via the communications connection to the terminal device an image that is displayed by the display processing means.

The foregoing configuration sends to the terminal device an image that is displayed by the display processing means, thus allowing the terminal device to also display the image. This allows the user of the terminal device to view the image at his/her own terminal device and easily recognize who is using which seat.

Further, the information processing device is preferably configured to further include position information sending means which sends, via the communications connection to the terminal device, position information indicating a seat position determined by the position determining means and the user identifying information, with the position information and the user identifying information being associated with each other.

The foregoing configuration sends to the terminal device a seat position determined by the position determining means and user identifying information, thus allowing the terminal device to determine, upon receiving them, which user is in which seat position. This makes it possible for the terminal device to display a seat position and either user identifying information or a user name, for example, with the seat position and either the user identifying information or the user name being associated with each other.

Further, a terminal device of Embodiment 2 is a terminal device that is in communications connection with the information processing device, including: a light-emitting section; identifying information sending means which sends via the communications connection to the information processing device user identifying information identifying a user who uses the terminal device; and light emission control means which causes the light-emitting section to emit light.

According to the foregoing configuration, the identifying information sending means sends the user identifying information to the information processing device, and the light emission control means causes the light-emitting section to emit light. This allows the information processing device to determine the user who uses the terminal device and determine, by detecting the light-emitting section emitting light, a seat position in which the terminal device has been placed.

Therefore, the foregoing configuration allows the information processing device to determine the seat position of a user identified by the user identifying information.

Further, a terminal device of Embodiment 2 is a terminal device that is in communications connection with the information processing device, including: a display section which displays an image; a light-emitting section; identifying information sending means which sends via the communications connection to the information processing device user identifying information identifying a user who uses the terminal device; light emission control means which causes the light-emitting section to emit light; and terminal-side display processing means which receives an image sent from the image sending means of the information processing device and displays the image on the display section.

The foregoing configuration receives an image that is displayed by the display processing means of the information processing device and displays the image on the display section of the terminal device. This allows the user of the terminal device to view the image at his/her own terminal device.

Further, a terminal device of Embodiment 2 is a terminal device that is in communications connection with the information processing device, including: a display section which displays an image; a light-emitting section; identifying information sending means which sends via the communications connection to the information processing device user identifying information identifying a user who uses the terminal device; light emission control means which causes the light-emitting section to emit light; and terminal-side display processing means which receives position information and user identifying information sent from the position information sending means of the information processing device, and which displays, on the display section, a seat position indicated by the position information and either the user identifying information or a user name of a user identified by the user identifying information, with the seat position and either the user identifying information or the user name being associated with each other.

The foregoing configuration receives position information and user identifying information from the information processing device and displays, on the display section, a seat position indicated by the position information and either the user identifying information or a user name of a user identified by the user identifying information, with the seat position and either the user identifying information and the user name being associated with each other. This allows the user of the terminal device to confirm, at his/her own terminal device, which user is using which seat.

Further, a terminal device of Embodiment 2 is a terminal device, placed in any one of a plurality of predetermined candidate positions, which is in communications connection with the information processing device, including: a display section which displays an image; a light-emitting section; identifying information sending means which sends via the communications connection to the information processing device user identifying information identifying a user who uses the terminal device; light emission control means which causes the light-emitting section to emit light; and terminal-side display processing means which displays, on the display section, an image showing an arrangement of the plurality of candidate positions and which displays that one of the plurality of candidate positions shown in the image which corresponds to a seat position indicated by position information sent by the position information sending means of the information processing device and either the user identifying information or a user name of a user identified by the user identifying information, with either the user identifying information or the user name being associated with the candidate position.

In a case where a candidate position in which the terminal device is placed is known beforehand, the seat position of each user and either the user identifying information corresponding to the seat position or a user name of a user identified by the user identifying information can be displayed on the display section of the terminal device as described above. This allows the user of the terminal device to confirm, at his/her own terminal device, which user is using which seat.

Further, the terminal device of Embodiment 2 is preferably configured such that the terminal-side display processing means displays an image of a seating chart representing each of the plurality of candidate positions as a seat and displays the seating chart in such a manner that the front of a seat at which the user identifying information or user name of the user of the terminal device has been displayed faces upward on the seating chart.

According to the foregoing configuration, the image of front of a seat corresponding to a candidate position in which the terminal device has been placed faces upward. With this, the frontward direction in which the user of the terminal is facing and the orientation of seats displayed on the display section of the terminal device can be matched. This allows the user to easily grasp the positional relationship between the seats.

Further, an information processing system including the information processing device and the terminal device that is in communications connection with the information processing device brings about the same effects as those brought about by the information processing device and the terminal device. It should be noted that the information processing system may include both/either the detection device and/or a display device which the display processing means causes to display an image.

It should be noted that the information processing device and the terminal device may be realized by computer. In this case, a control program for causing the information processing device and the terminal device to be realized by computer by causing a computer to operate as each means of the information processing device and the terminal device and a computer-readable recording medium containing such a control program are also encompassed in the scope of the present invention.

### INDUSTRIAL APPLICABILITY

The present invention can be applied to electronic conferencing systems.

### REFERENCE SIGNS LIST

1 Server (information processing device)
2 Display device
3 Imaging device (detection device)
5 Terminal (terminal device)
11 Display processing section (display processing means)
12 Imaging device control section (direction determining means)
13 Position determining section (identifying information receiving means, terminal control means, position determining means, image sending means, candidate position sending means)
15 Memory section
18 Seat position information (position-to-direction correspondence information)
20 Display section
21 LED (light-emitting section)
24 Display processing section (terminal-side display processing means)
25 LED control section (light emission control means)
26 Position determining section (identifying information sending means)
100 Electronic conferencing system (information processing system)
1′ Server (information processing device)
5′ Terminal (terminal device)
12′ Imaging device control section (direction determining means, distance determining means)
13′ Position determining section (identifying information receiving means, terminal control means, position determining means, image sending means, position information sending means)
26′ Position determining section (identifying information sending means)
100′ Electronic conferencing system (information processing system)

1. An information processing device that is in communications connection with a terminal device including a light-emitting section, comprising:
direction determining means which uses a detection device to detect the light-emitting section emitting light at the terminal device and which determines in which direction the light-emitting section is located with respect to the detection device;
identifying information receiving means which receives via the communications connection from the terminal device user identifying information identifying a user who uses the terminal device; and
position determining means which determines, by using the direction determined by the direction determining means and information for determining the position of the terminal device in the direction, the position of the terminal device of the user identified by the user identifying information received by the identifying information receiving means.

2. The information processing device as set forth in claim 1, further comprising a memory section in which to store position-to-direction correspondence information indicating, for a plurality of candidate positions in which the terminal is placed, in which direction each candidate position is located with respect to the detection device, wherein the position determining means determines, by using the position-to-direction correspondence information stored in the memory section and the direction determined by the direction determining means, in which of the plurality of candidate positions the terminal device of the user identified by the user identifying information received by the identifying information receiving means has been placed.

3. The information processing device as set forth in claim 1, further comprising terminal control means which, by transmitting a command via the communications connection to a terminal device from which the identifying information receiving means has received user identifying information, causes the light-emitting section of the terminal device to emit light.

4. The information processing device as set forth in claim 1, further comprising display processing means which displays an image showing the plurality of candidate positions and which displays, in a candidate position determined by the position determining means, user identifying information corresponding to the candidate position or a user name of a user identified by the user identifying information.

5. The information processing device as set forth in claim 1, further comprising candidate position sending means which sends via the communications connection to the terminal device a candidate position determined by the position determining means and user identifying information corresponding to the candidate position, with the candidate position and the user identifying information being associated with each other.

6. The information processing device as set forth in claim 1, further comprising distance determining means which determines the distance from the detection device to the light-emitting section, wherein
the position determining means determines, as the seat position of the user identified by the user identifying information received by the identifying information receiving means, a position away from the detection device by the distance determined by the distance determining means in the direction determined by the direction determining means.

7. The information processing device as set forth in claim 6, wherein:
the detection device is a device which takes an image; and
the direction determining means detects the light-emitting section by causing an imaging region of the detection device to rotate on the detection device and determines, as the direction in which the light-emitting section is located, an angle of rotation of the imaging region at which the light-emitting section has been detected.

8. The information processing device as set forth in claim 7, wherein:
the detection device has a function of measuring the distance from the detection device to an object to be imaged and focusing on the object to be imaged by using the distance thus measured; and
the distance determining means determines, as the distance from the detection device to the light-emitting section, the distance measured by the detection device for focusing on the light-emitting section.

9. The information processing device as set forth in claim 6, said information processing device being in communications connection with a plurality of terminal devices each including a light-emitting section, further comprising:
display processing means which displays each seat position determined by the position determining means separately for the plurality of terminal devices and either the user identifying information corresponding to the seat position or a user name of a user identified by the user identifying information, with the seat position and either the user identifying information or the user name being associated with each other.

10. The information processing device as set forth in claim 6, wherein the terminal device is placed in any one of a plurality of predetermined candidate positions,
said information processing device further comprising display processing means which displays an image showing an arrangement of the plurality of candidate positions and which displays, in that one of the plurality of candidate positions shown in the image which corresponds to the position determined by the position determining means, the user identifying information or a user name of a user identified by the user identifying information.

11. The information processing device as set forth in claim 4, further comprising image sending means which sends via the communications connection to the terminal device an image that is displayed by the display processing means.

12. The information processing device as set forth in claim 6, further comprising position information sending means which sends, via the communications connection to the terminal device, position information indicating a seat position determined by the position determining means and the user identifying information, with the position information and the user identifying information being associated with each other.

13. A terminal device that is in communications connection with an information processing device as set forth in claim 1, comprising:
the light-emitting section;
identifying information sending means which sends via the communications connection to the information processing device user identifying information identifying a user who uses the terminal device; and
light emission control means which causes the light-emitting section to emit light.

14. A terminal device that is in communications connection with an information processing device as set forth in claim 11, comprising:
a display section which displays an image;
the light-emitting section;
identifying information sending means which sends via the communications connection to the information processing device user identifying information identifying a user who uses the terminal device;
light emission control means which causes the light-emitting section to emit light; and
terminal-side display processing means which receives an image sent from the image sending means of the information processing device and displays the image on the display section.

15. A terminal device that is in communications connection with an information processing device as set forth in claim 5, comprising:
a display section which displays an image;
the light-emitting section;
identifying information sending means which sends via the communications connection to the information processing device user identifying information identifying a user who uses the terminal device;
light emission control means which causes the light-emitting section to emit light; and
terminal-side display processing means which receives a plurality of candidate positions and user identifying information sent from the candidate position sending means of the information processing device, which displays an image showing the plurality of candidate positions, and which displays, in each candidate position in the image, the user identifying information corresponding to the candidate position or a user name of a user identified by the user identifying information.

16. The terminal device as set forth in claim 15, wherein:
the image showing the plurality candidate positions is an image of a seating chart on which seats respectively corresponding to the candidate positions have been drawn; and
the terminal-side display processing means displays the image of the seating chart in such an orientation that the front of a seat corresponding to a candidate position in which the terminal device has been placed faces upward in the image.

17. A terminal device that is in communications connection with an information processing device as set forth in claim 12, comprising:
a display section which displays an image;
a light-emitting section;
identifying information sending means which sends via the communications connection to the information processing device user identifying information identifying a user who uses the terminal device;
light emission control means which causes the light-emitting section to emit light; and
terminal-side display processing means which receives position information and user identifying information sent from the position information sending means of the information processing device, and which displays, on the display section, a seat position indicated by the position information and either the user identifying information or a user name of a user identified by the user identifying information, with the seat position and either the user identifying information or the user name being associated with each other.

18. A terminal device, placed in any one of a plurality of predetermined candidate positions, which is in communications connection with an information processing device as set forth in claim 12, comprising:
a display section which displays an image;
a light-emitting section;
identifying information sending means which sends via the communications connection to the information processing device user identifying information identifying a user who uses the terminal device;
light emission control means which causes the light-emitting section to emit light; and
terminal-side display processing means which displays, on the display section, an image showing an arrangement of the plurality of candidate positions and which displays that one of the plurality of candidate positions shown in the image which corresponds to a seat position indicated by position information sent by the position information sending means of the information processing device and either the user identifying information or a user name of a user identified by the user identifying information, with either the user identifying information or the user name being associated with the candidate position.

19. The terminal device as set forth in claim 18, wherein the terminal-side display processing means displays an image of a seating chart representing each of the plurality of candidate positions as a seat and displays the seating chart in such a manner that the front of a seat at which the user identifying information or user name of the user of the terminal device has been displayed faces upward on the seating chart.

20. An information processing system comprising:
an information processing device as set forth in claim 1; and
the terminal device that being in communications connection with the information processing device, comprising:
the light-emitting section;
identifying information sending means which sends via the communications connection to the information processing device user identifying information identifying a user who uses the terminal device; and
light emission control means which causes the light-emitting section to emit light.

21. A method for controlling an information processing device that is in communications connection with a terminal device including a light-emitting section, comprising the steps of:
(a) using a detection device to detect the light-emitting section emitting light at the terminal device and determining in which direction the light-emitting section is located with respect to the detection device;
(b) receiving via the communications connection from the terminal device user identifying information identifying a user who uses the terminal device; and
(c) determining, by using the direction determined in step (a) and information for determining the position of the terminal device in the direction, the position of the terminal device of the user identified by the user identifying information received in step (b).

22. A non-transitory computer-readable recording medium containing control program for causing a computer to operate as an information processing device as set forth in claim 1, said control program causing the computer to functions as each of the means.

23. A non-transitory computer-readable recording medium containing control program for causing a computer to operate as a terminal device as set forth in claim 13, said control program causing the computer to functions as each of the means.

24. (canceled)
